(19) United States
(12) Patent Application Publication
(10) Pub. No.: US 2008/0286730 A1
(43) Pub. Date: Nov. 20, 2008

(54) Immersive Imaging System, Environment and Method for Le

(76) Inventor: Raul Vega Romero, JR., Los Angeles, CA (US)

Correspondence Address: K.F. ROSS P.C., 5683 RIVERDALE AVENUE, SUITE 203 BOX 900, BRONX, NY, 10471-0900, US

(21) Appl. No.: 12/091,304

(22) PCT Filed: Oct. 31, 2006
(86) PCT No.: PCT/US06/42630

§ 371 Date: Apr. 24, 2008

Related U.S. Application Data
(60) Provisional application No. 60/737,854, filed on Nov. 17, 2005.

(51) Int. Cl. G09B 19/06; G09B 19/08; G09B 5/06

(52) U.S. Cl. 434/157; 434/169; 434/185; 434/308; 345/473

(57) ABSTRACT

Immersive imaging system for learning a language comprising at least a first level, this first level including:
d) a first activity that introduces a user of the system to the meaning and sound of a piece of spoken language;
e) a second activity that works the visual mapping of spoken language on a picture matrix; and
f) a third activity that works the narrative mapping of spoken language.

### OBJECT OF THE INVENTION

The invention provides a learning system and environment for teaching a language, usually a second language. The invention furthermore provides a method for learning a language.

### BACKGROUND OF THE INVENTION

U.S. Pat. No. 5,885,083 discloses a system and method for multimodal interactive speech training that includes selecting a modality corresponding to various sensory stimuli to present non-native vocabulary elements.

U.S. Pat. No. 6,022,222 discloses a computerized system for learning a natural language through the visual depiction of grammar.

U.S. Pat. No. 6,328,569 relates to a method for training of auditory and graphical discrimination in humans, providing an animated game environment. The method provides a number of stimulus sets, each stimulus set having a target phoneme and a plurality of associated foils. This invention is aimed at children having a language-learning impairment (LLI) who cannot accurately process short duration acoustic events at the rates that occur in normal speech. A similar invention is disclosed in U.S. Pat. No. 6,331,115.

The prior art has not provided a learning system, environment or method as provided by the present invention. There remains a need for a system, environment and method of learning a language that teaches a language in a way that spoken language quickly and easily becomes imprinted in the memory of the learner, and may be readily recalled and re-performed by the learner.

### SUMMARY OF THE INVENTION

An object of the invention is to provide an immersive imaging system for learning a language comprising at least a first level, said first level comprising:
(a) a first activity that introduces a user of the system to the meaning and sound of a piece of spoken language;
(b) a second activity that works the visual mapping of spoken language on a picture matrix; and
(c) a third activity that works the narrative mapping of spoken language.

Preferably, the immersive imaging system for learning a language of the invention may further comprise a second level. The second level may comprise an activity that visually maps a spoken language to a coordinate on a picture matrix. The second level may further comprise a second activity that works visual mapping of a spoken language. Additionally, the second level further comprises an activity that works narrative mapping of a spoken language. Preferably, the activities of the second level are combined to achieve the best memory reinforcement effect in the user of the system for the spoken language.

Preferably, the immersive imaging system for learning a language of the invention further comprises a third level of language immersion involving mnemonic and performative immersion for elements of spoken interaction. For example, this level may involve recursive spoken interaction with a human actor, for example, an actor that appears on the computer screen.

The immersive imaging system of the invention is preferably provided as software on a CD-ROM. However, other media may be used for the system, such as portable digital video players, MP3 players, smart phones and game consoles. In the case of an MP3 player, for example, certain activities could be adapted or deleted from the system to conform with the limitations of this medium. Instead of interacting with a computer, a learner might interact with an MP3 player, while viewing and interacting with single pages in a book which portray the same kind of mnemonic, matrixed information displays embodied in the environment of the invention.

In the case of a portable digital video player certain activities could also be adapted or deleted from the system to conform with the limitations of this medium. Instead of interacting with a computer, a learner might interact with a portable digital video player, while viewing and interacting with video segments that portray the same kind of mnemonic, matrixed information displays embodied in the environment of the invention. Additionally, on this same medium a learner might also interact with serial video segments that portray the same kind of mnemonic and performative immersion with a cast of live actors for specific elements of spoken human interaction embodied in the environment of the invention.

The immersive imaging system for learning a language of the invention preferably involves an interaction between the user and a computer. The activities of the system of the invention may also be web-based activities.

An alternative embodiment of the invention is an animated environment for learning a language comprising:
(a) audio patterning of spoken language by the use of spoken syllable indicators to create a visual interface for the audio being heard;
(b) visual patterning by mapping the voiced audio to a consistent visual referent;
(c) narrative patterning by mapping words and phrases to individual characters, places, objects, events and/or times.

Another embodiment of the invention is a method of teaching a language to a human user by an immersive imaging system, which method comprises:
(d) presenting the user with an audio pattern of spoken language elements by the use of spoken syllable indicators to create a visual interface;
(e) reinforcing the memory of the user for the spoken language element by visual patterning by mapping the voiced audio to a consistent visual referent; and
(f) further reinforcing the memory of the user for the spoken language element by narrative patterning by mapping words and phrases to individual characters, places, objects, events and/or times.

In the system, environment or method of the invention, the user preferably actively participates in the immersive imaging system. Preferably, the user is interacting with a computer.

### DESCRIPTION OF THE DRAWINGS

FIG. 1 is a flow chart of an example of the first level of the system of the invention.

FIG. 2 is a flow chart of an example of the second level of the system of the invention.

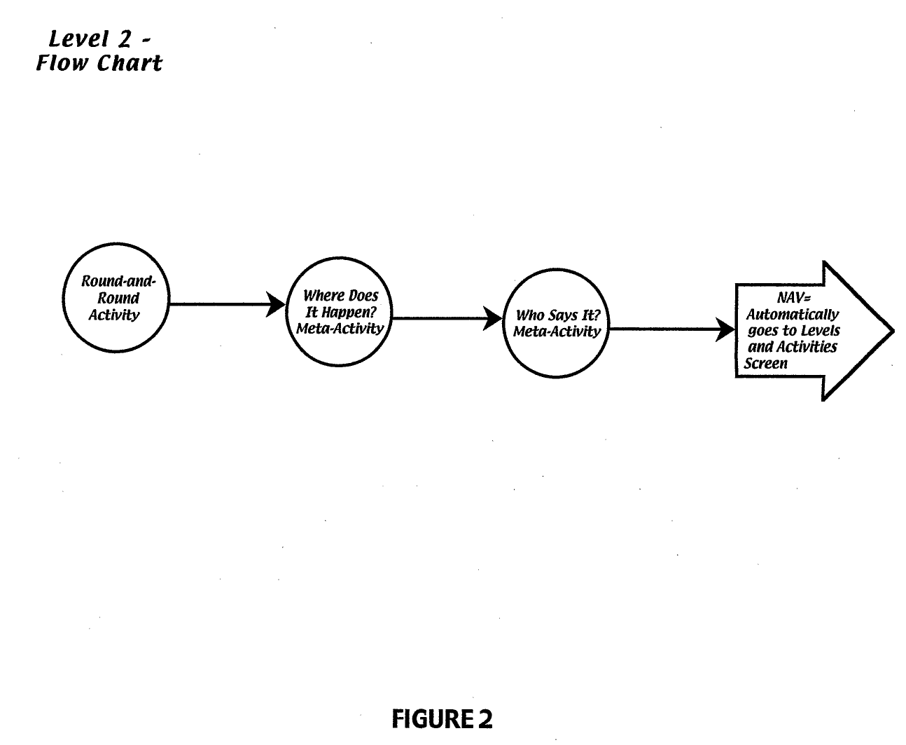

FIG. 3 is a screen design example of a Performing Picture-Page with four Main Pictures, four Detail Pictures and one Center Picture.

FIG. 4 is a screen design example of the “Acciones—En casa” (Actions—At home), Sub-Menu selection screen.

FIG. 5 is a flow chart of the First Look Activity of Level 1.

FIG. 6 is a screen design example of the First Look Activity of Level 1, “Acciones—En casa—Los cuartos” (Actions—At home—Rooms) page.

FIG. 7 is a flow chart of the First Say Activity of Level 1.

FIG. 8 is a screen design description of the First Say Activity, “El dormitorio” [The bedroom] Room Announcement Event of Level 1.

FIG. 9 is a screen design example of the First Say Activity of Level 1, “Acciones—En casa—En el dormitorio” (Actions—At home—In the bedroom), beginning state.

FIG. 10 is a screen design example of the First Say Activity of Level 1, in progress, Talking Notes empty.

FIG. 11 is a screen design example of the First Say Activity of Level 1, in progress, Talking Notes colored in.

FIG. 12 is a screen design example of the First Say Activity of Level 1, one Talking Note filled in, demonstrating the Reverse Recursion method in progress.

FIG. 13 is a flow chart of the First Say Activity of Level 1, Reverse Recursion method, revelation and processing of “le—van—TAR—me” (to get up).

FIG. 14 is a flow chart of the Rebuild the Page Activity of Level 1.

FIG. 15 is a screen design example of the Rebuild the Page Activity of Level 1, beginning state, all picture frames empty, Listen-Boxes at bottom of screen.

FIG. 16 is a screen design example of the Rebuild the Page Activity of Level 1, in progress, the page partially rebuilt, two Main Pictures plus their Detail Pictures have now been put back.

FIG. 17 is a screen design example of the Rebuild the Page Activity of Level 1, Applause Event at end of activity.

FIG. 18 is a flow chart of the Who Says It? Activity of Level 1.

FIG. 19 is a screen design example of the Who Says It? Activity of Level 1, beginning state, Main Pictures replaced by Listen-Boxes, portraits of six Characters at bottom of page.

FIG. 20 is a screen design example of the Who Says It? Activity of Level 1, in progress, two of the Listen-Boxes on the Picture Wheel have returned to being Main Picture images.

FIG. 21 is a flow chart of the Round-and-Round Activity of Level 2.

FIG. 22 is a screen design example of the Round-and-Round Activity of Level 2, beginning state.

FIG. 23 is a screen design example of the Round-and-Round Activity of Level 2, in progress, Rounds 1 and 2, one Main Picture and its collocated Detail Picture highlighted.

FIG. 24 is a screen design example of the Round-and-Round Activity of Level 2, in progress, Round 3, all Main Picture and Detail Picture images gone (Center Picture still visible), only empty picture frames remain, one empty Main Picture frame and its collocated empty Detail Picture frame highlighted.

FIG. 25 is a flow chart of the Where Does It Happen? Meta-Activity of Level 2.

FIG. 26 is a screen design example of the Where Does It Happen? Meta-Activity of Level 2, in progress.

FIG. 27 is a flow chart of the Who Says It? Meta-Activity of Level 2.

FIG. 28 is a screen design example of the Who Says It? Meta-Activity of Level 2, beginning state.

FIG. 29 is a flow chart of the Let's Talk! Activity of Level 3.

FIG. 30 is a screen design example of the Let's Talk! Activity of Level 3, beginning state.

### DETAILED DESCRIPTION OF THE INVENTION

The invention animates a spoken, spontaneous, everyday language. The system, environment or method of the invention is auditory, visual, performative, and participatory. The learning system and environment is most preferably text-free. Most preferably, no printed words are used to teach and learn spoken language. This allows focus of attention on consistently presented elements—voice, sound effects, pictures, videotaped gestures and expressions—through each progressive level of learning in order to maximize the learner's ability to map language into memory. The system and environment of the invention does not involve translating, but rather, teaches what the word or phrase itself is in order to enable speech.

In the system, environment or method of the invention, language is learned imagistically and synaesthetically. Language is learned imagistically, via immersive auditory, visual, kinesthetic and affective imagery. These different types of imagery are multiplexed and delivered together, for example, in Immersive Imaging Eyents (IIE's). These IIE's produce a synaesthetic effect in the learner. For example, by just seeing or recalling a specific picture or sound effect in memory, and/or its matrixed positioning on a page, the learner will also be able to orally produce a specific word or phrase that represents that piece of second language. Or, vice versa, by hearing someone say a particular word or phrase in the second language, the learner will perceive in memory the picture or sound effect, or both, that signifies the meaning_of this piece of spoken language.

The system, environment or method of the invention may further be characterized by the mapping of spoken language onto a text-free, non-linear, mnemonic, imagery-syndetic information superstructure called the Imaging Super-Matrix (ISM). The invention presents/performs auditory, visual, kinesthetic, narrative and/or dramatic imagery in a mnemonic learning system and environment. Students thus learn (integrate) an entire multiplexed Immersive Imaging Event (IIE) in combination. They learn, take into memory, the entire imagistic performance. Spoken language is retained in memory because of the multiple “hooks” upon which it is associated. It is the entire combinatorial effect of all of these performance and participatory features/dynamics that make this learning system and environment (interface) unique. The system and environment achieves an overall speech enabling effect for second language learners.

The audio is presented processually and recursively, for example, with Talking Notes and Reverse Recursion, and preferably with Bolding, a deliberately slowed down, super-articulate, exaggerated pronunciation technique.

A combination of imagery elements is used synaesthetically and syndetically—e.g. picture plus sound effects, plus matrixed visual mapping on a page, plus matrixed visual mapping of a page to the Imaging Super-Matrix, plus dramatic performance—to map spoken language and expression into memory.

The learner using the system and environment, preferably, takes an active participatory (or performance) role throughout the learning process, in every Level and Activity of the language learning system. Students will, e.g., be encouraged to use some of the same props during the Learner Rehearsal Spaces embedded in the timeline of running activities. They will be encouraged to mimic all of the speaking and dramatic delivery features that they see represented in the pictures and videos, and hear in the performative audio mapped to (embedded in) the pictures and videos (also during the Learner Rehearsal Spaces). This simulates the situation in a classroom where a student would be using a learning material for a highly immersive and experiential class on spoken language and interaction in that language. Alternatively, this simulates the situation in the real world of the five senses in which a learner would acquire her/his first language by interacting personally and immersively with people and animals, plant and vegetable life, events and situations, things, locales and other elements of daily life.

Finally, students who employ the system, and environment learn not just individual words and phrases, but entire natural groupings of words and expressions (Speaking Rehearsal Units). And each of these groupings is then syndetically connected—by strong, multiplexed imagery associations—to every other grouping in the mnemonic, matrixed, imagery superstructure (the Imaging Super-Matrix). Students learn to retrieve and reproduce the entire array of spoken language in the superstructure. And, because it is all mnemonically and syndetically connected (via multiplexed imagery associations), the superstructure acquires a generative capacity. When students wish to speak, they can quickly use their visual memory to find a picture of what they want to say and then say it.

Additionally, and most importantly, learners extensively rehearse (Speaking Rehearsal Patterning) both individual and logically combined elements of spoken, performative language. The entire system, method and environment is participatory in nature. For example, in many of the activities in the system, there are multiple and consecutive Learner Rehearsal Spaces—periods of silence embedded in the timeline of a running activity—during which the learner is to replicate and re-enact exactly what she/he has just heard.

The invention, preferably, utilizes a progressive layering of activities. The learner experiences and actively participates in a progressive layering of activities. Each activity targets a specific natural grouping of language (e.g., “Actions—At home”). Most preferably, the levels are combined to create recursive and immersive learning. A listing of the preferred embodiments of the activities as they progress from the elemental to the more complex are:

### Level 1:

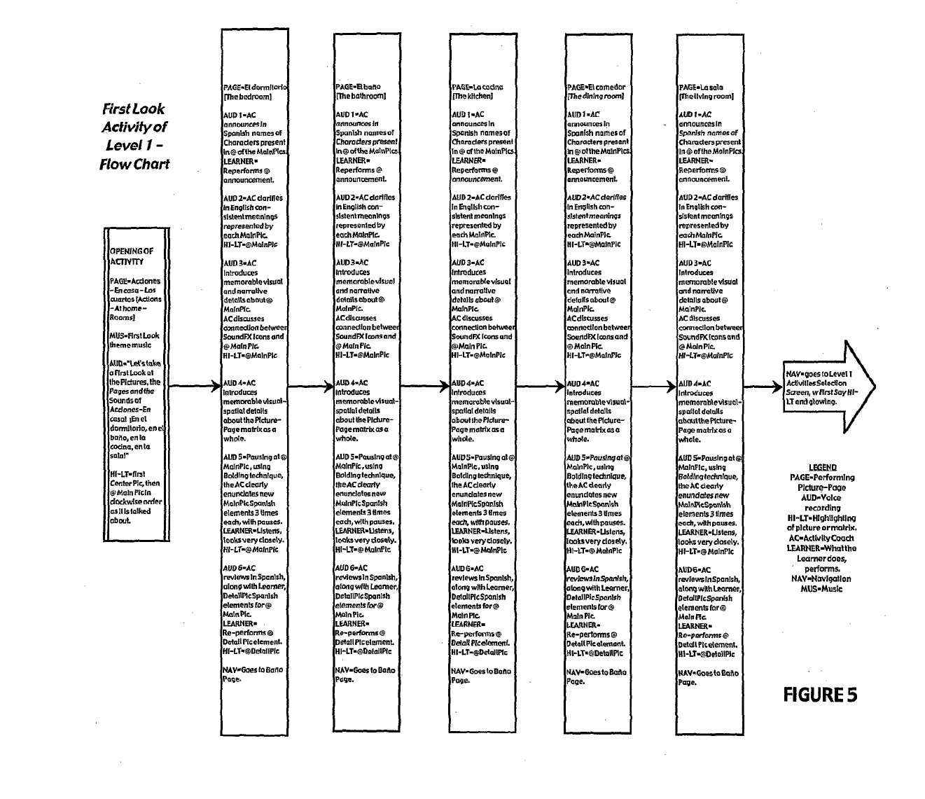

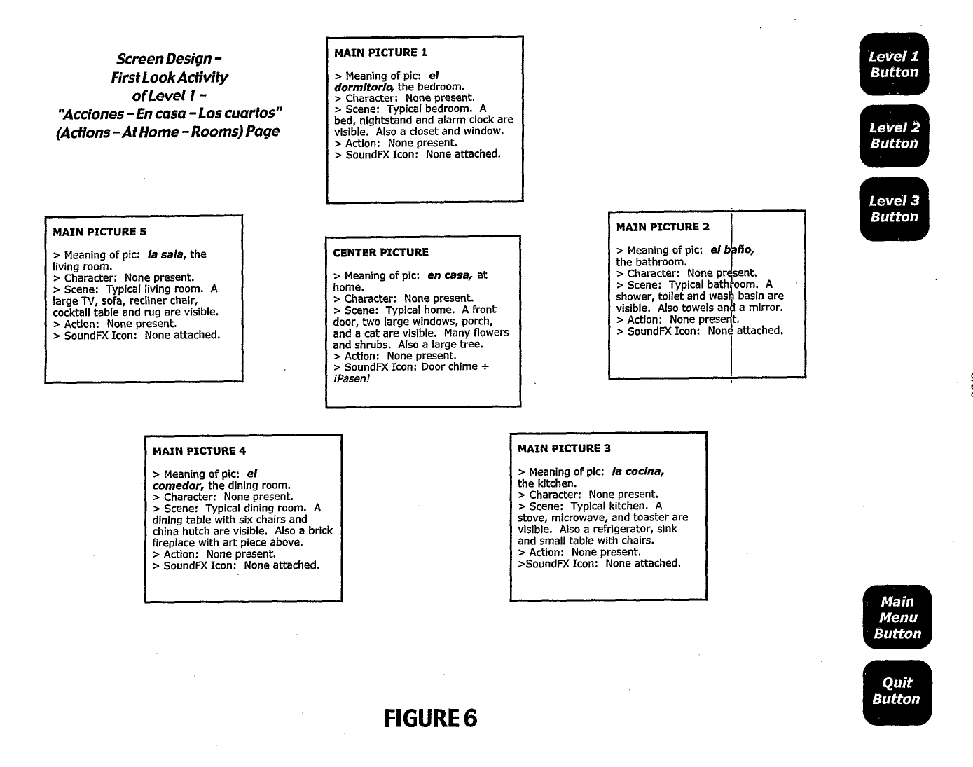

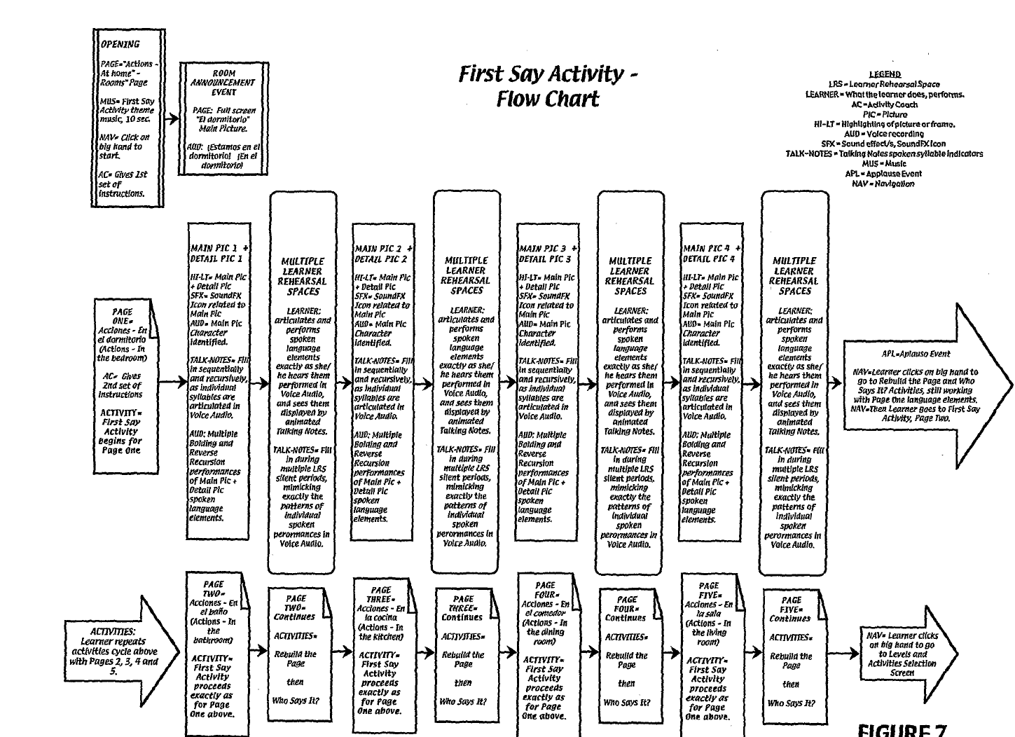

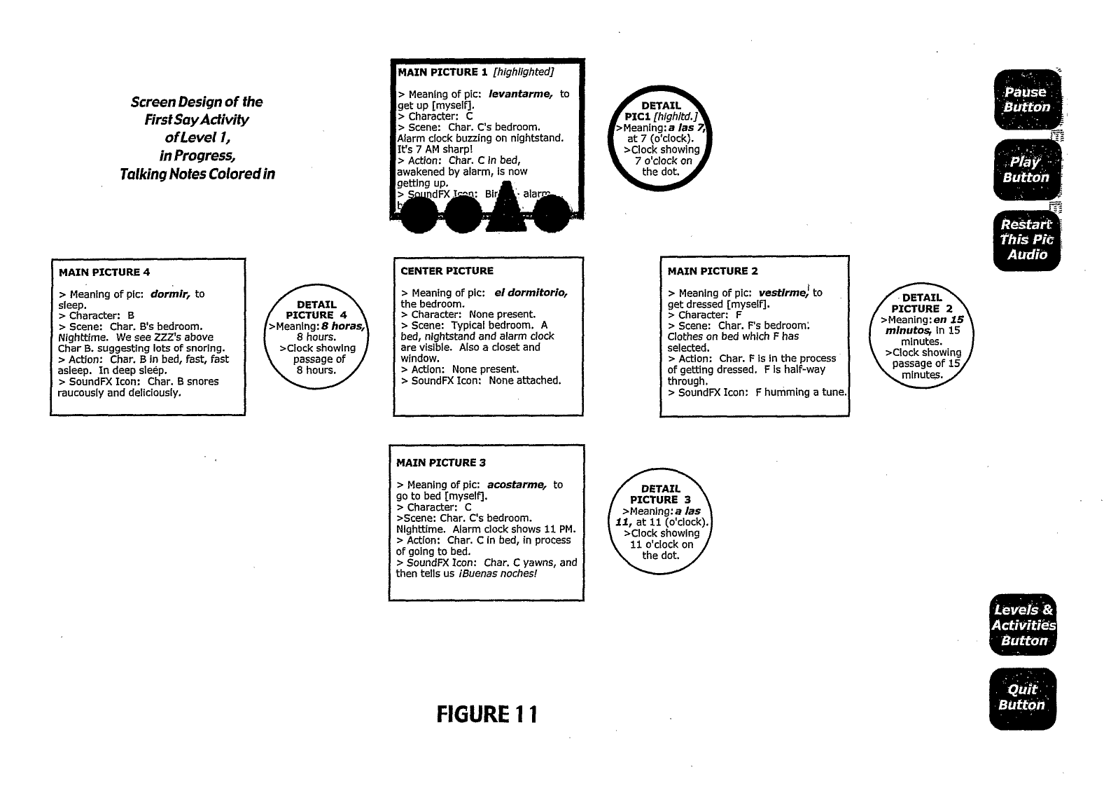

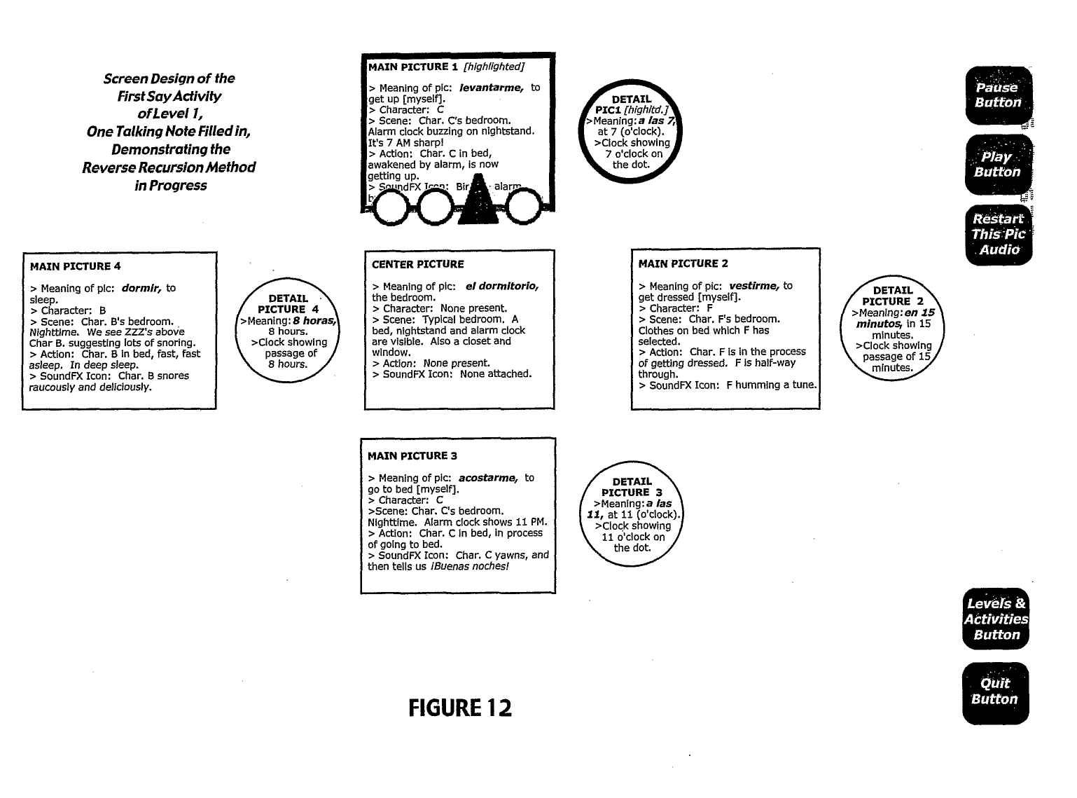

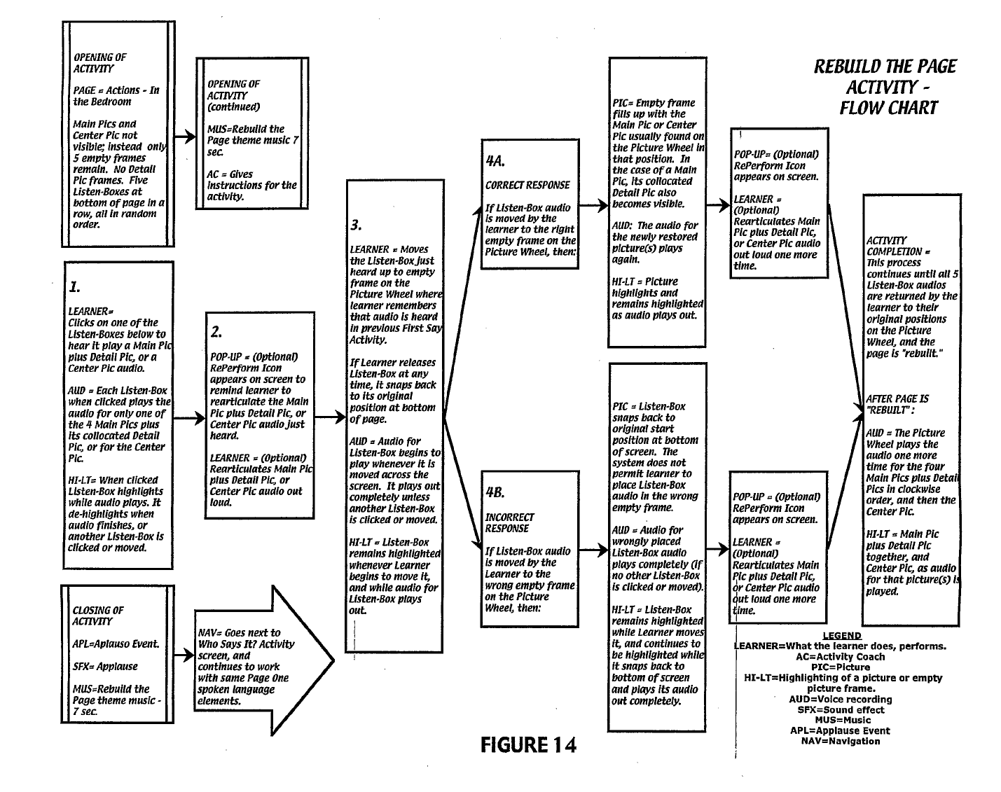

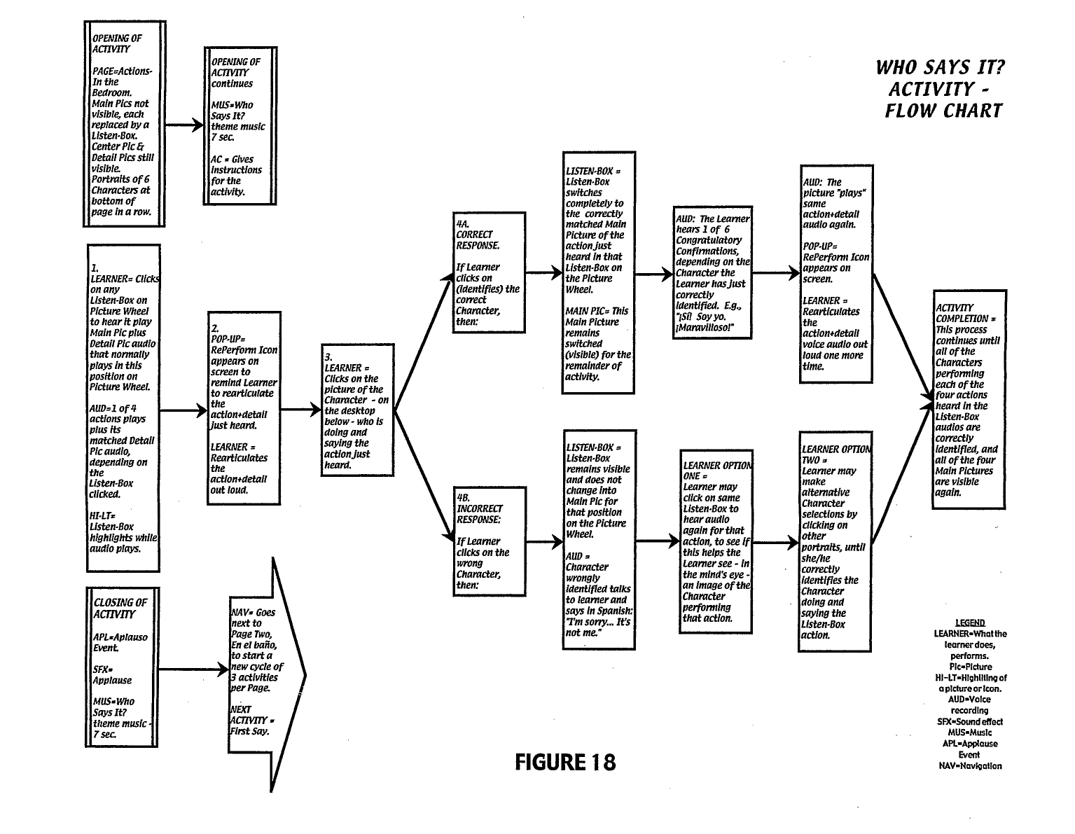

First Look Activity (see FIGS. 5-6): the initial introduction to the meaning and placement of individual pictures, works the visual mapping of individual elements of spoken language to specific pictures, and narrative mapping of spoken language to a specific character. It is conducted primarily in the native language of the learner. It is also a speaking rehearsal mapping activity.
First Say Activity (see FIGS. 7-13): primarily an intensive, speaking rehearsal patterning (mapping) activity, it is an immersive introduction to the individual sound features of a particular piece of spoken language, for example, by audio and visual patterning. It is also a kinesthetic and dramatic mapping activity of spoken language elements.
Rebuild the Page Activity (see FIGS. 14-17): works the visual mapping of spoken language onto a picture matrix, for example, in a clockwise direction. It is also a speaking rehearsal mapping activity.
Who Says It? Activity (see FIGS. 18-20): works the narrative (character) mapping of spoken language. It is also a speaking rehearsal mapping activity.

### Level 2:

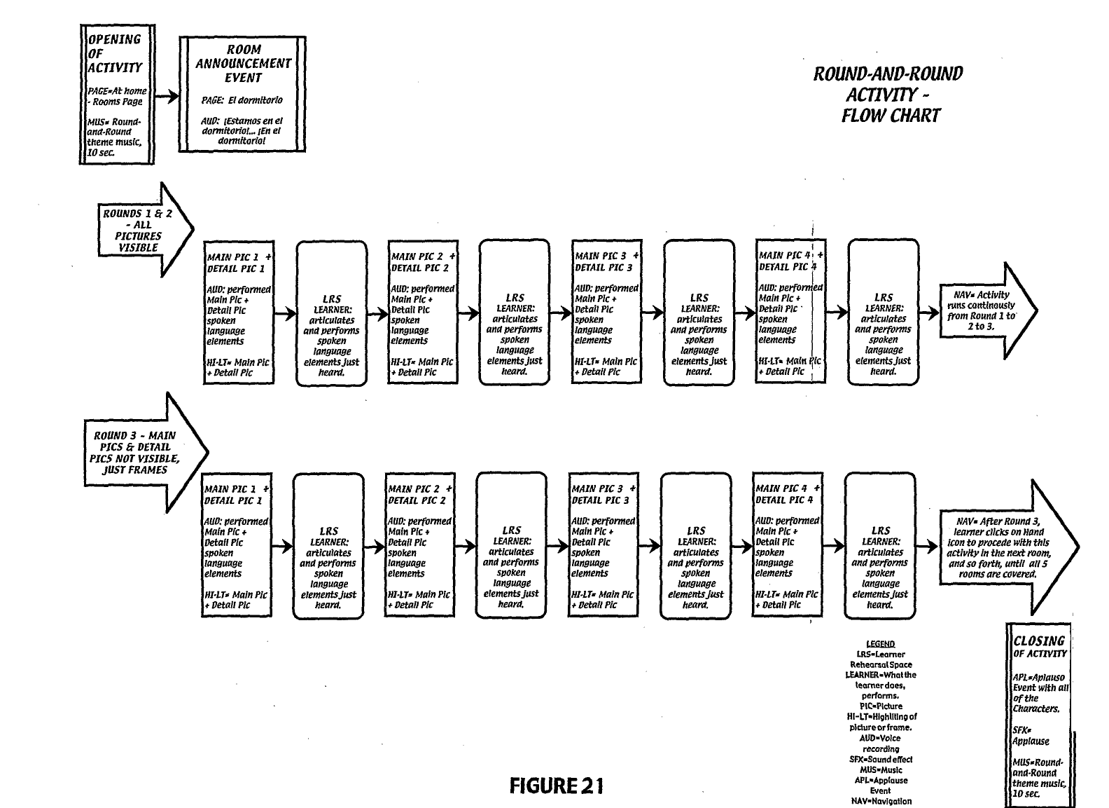

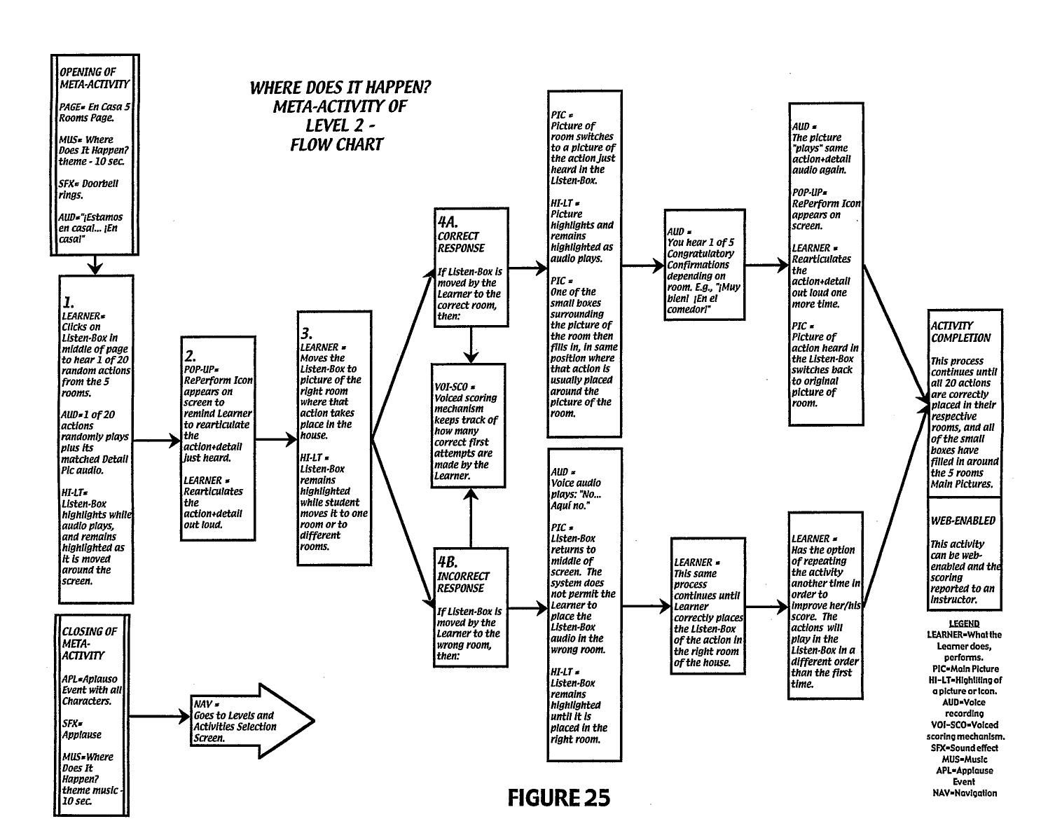

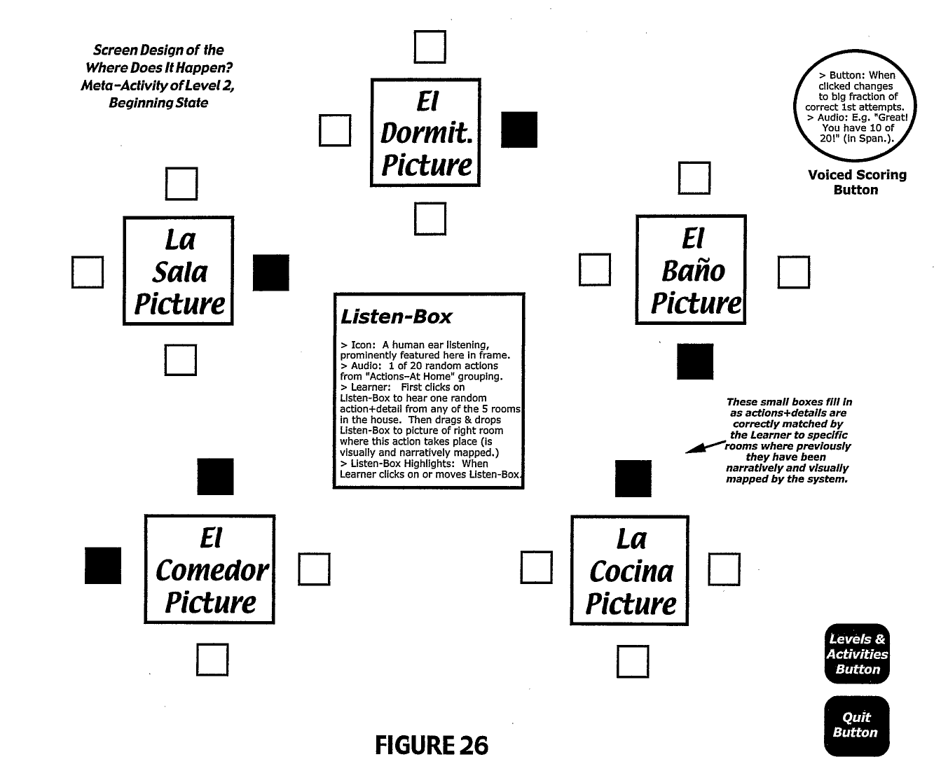

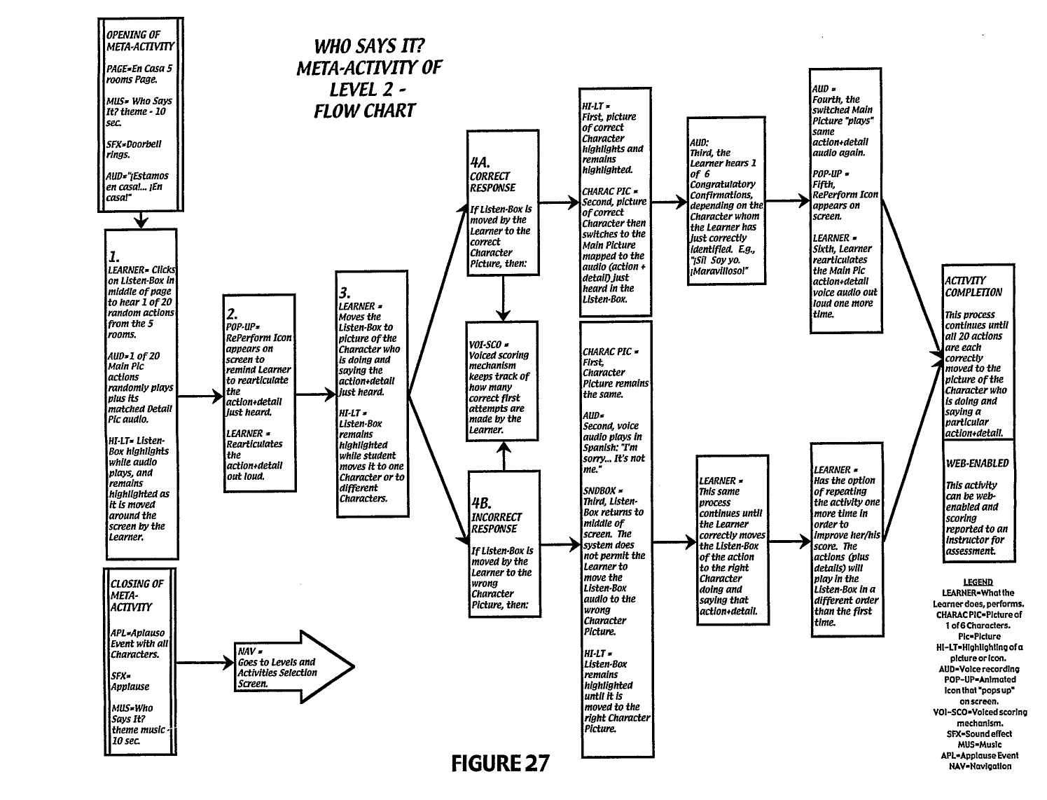

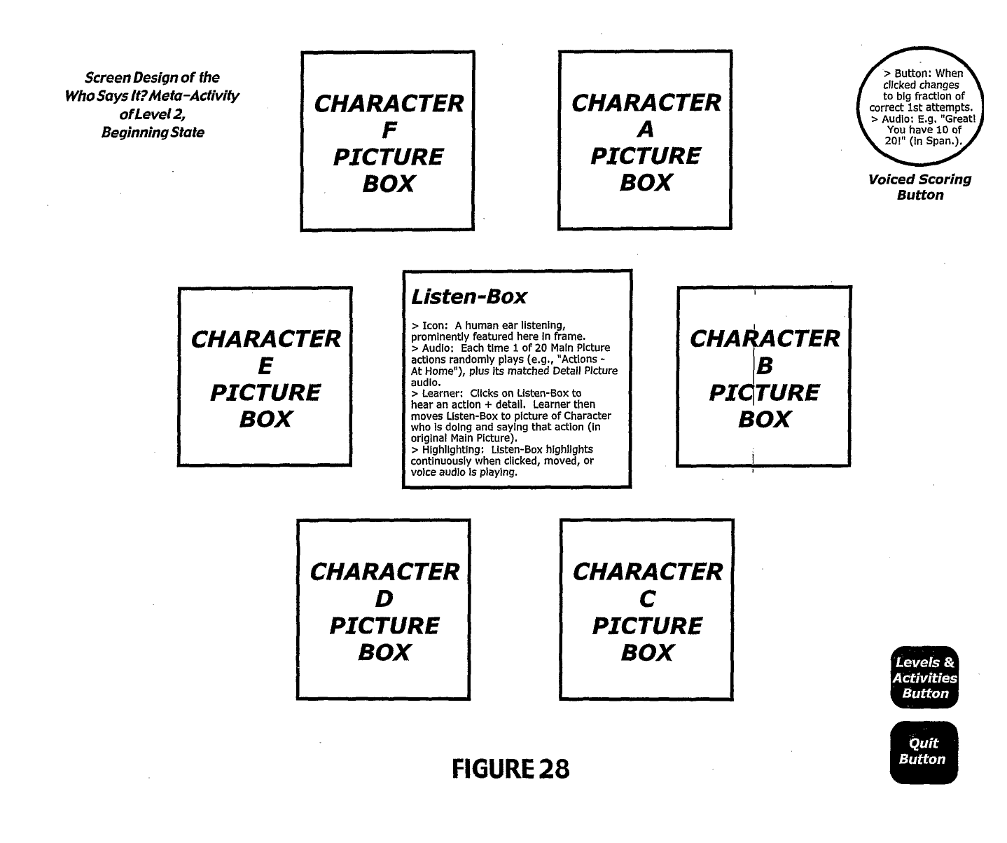

Round-and-Round Activity (see FIGS. 21-24): an intensive speaking rehearsal mapping activity, works the visual mapping of performed, spoken language to specific coordinates of a picture matrix.
Where Does it Happen? Meta-Activity (see FIGS. 25-26): works visual and narrative mapping of spoken language to a specific place on the Imaging Super-Matrix. It is also a speaking rehearsal mapping activity.
Who Says It? Meta-Activity (see FIGS. 27-28): works narrative (story) mapping of spoken language to a specific character for all of the Performing Picture-Pages in a given Speaking Rehearsal Unit. It is also a speaking rehearsal mapping activity.

### Level 3:

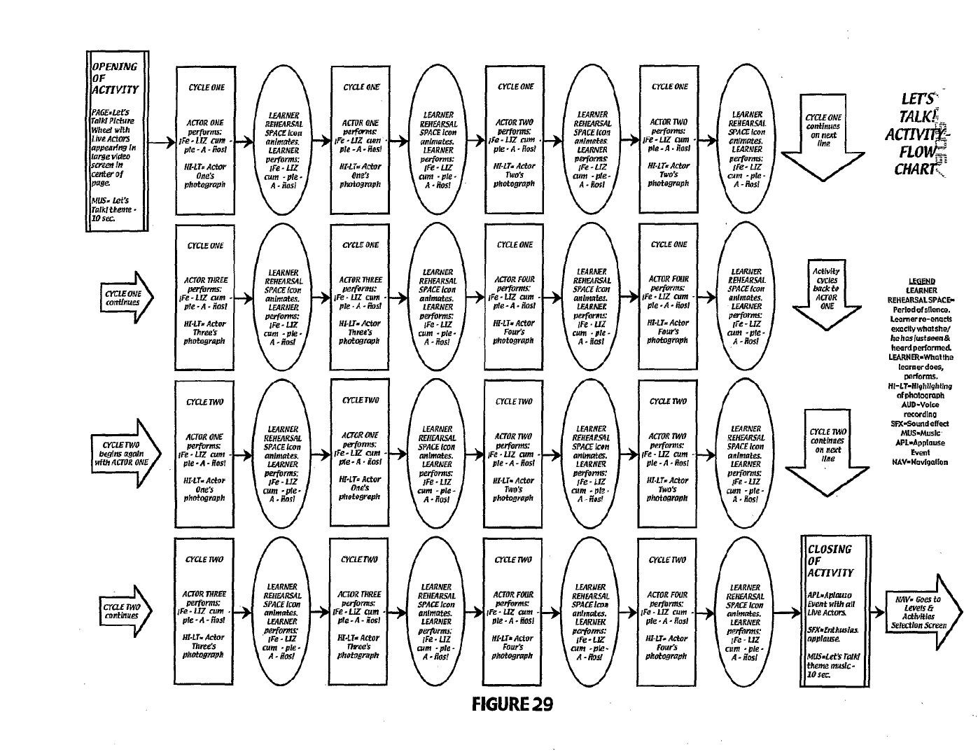

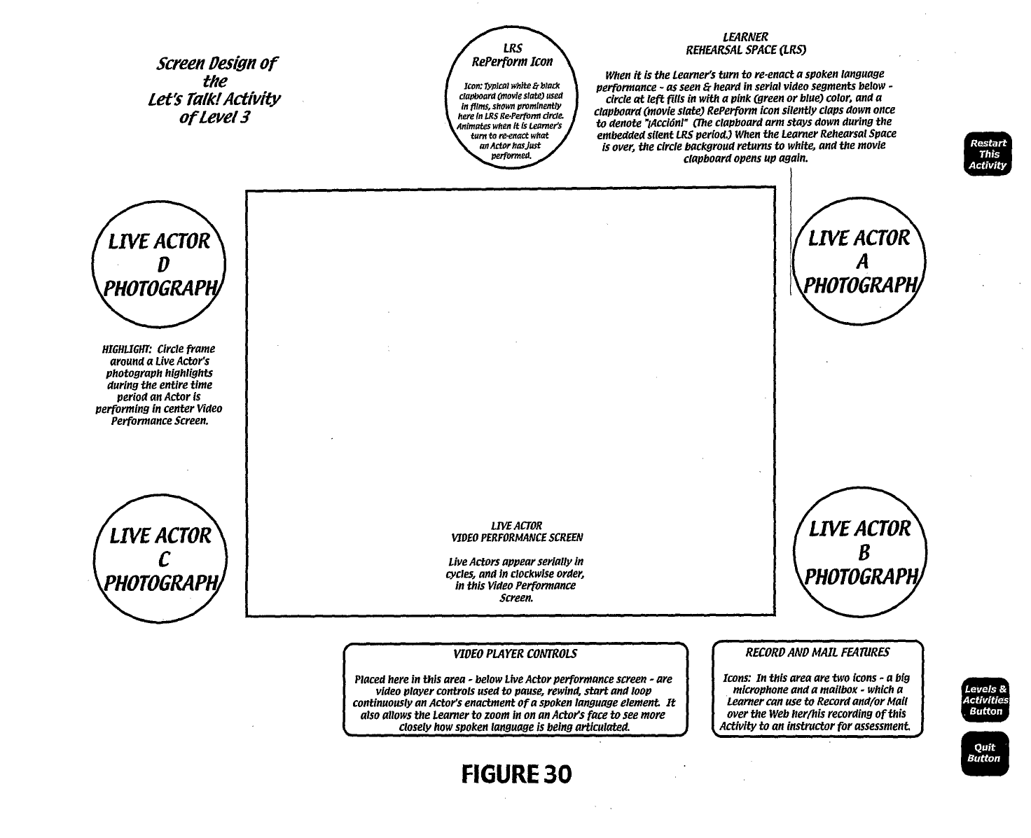

Let's Talk! Activity (see FIGS. 29-30): an intensive speaking rehearsal patterning (mapping) activity. Additionally, it is a dramatic and kinesthetic mapping activity. Creates language immersion at a higher level.

### Audio Patterning (Mapping) of Spoken (Performed) Language

Audio patterning of spoken language occurs, most preferably, with the Talking Notes spoken syllable indicators, which create a visual interface to guide a student in her/his performance and retrieval of new language being learned during the Learner Rehearsal Spaces (embedded in the timeline of a running activity). For example, different colors and shapes may be used, such as red circles and blue triangles, which fill up as each successive component sound of a word or phrase is voiced. These create a type of extreme karaoke.

Audio patterning also occurs with Bolding: the slowed down, overly articulated, even exaggerated sound features performance of the voice audio. Reverse Recursion of a word or phrase is also utilized, in which the last syllable of a longer word or phrase is presented first, and then the second to the last is presented with the last, and then the third to the last with the second to the last and the last, and so on, until the entire word or phrase is being articulated. After each performance of the voice audio there is a Learner Rehearsal Space, during which the student is encouraged to mimic, perform exactly what she/he has just heard immediately before.

Audio patterning also occurs with SoundFX (sound effects) Icons, individual sound effects and ambient sounds which are often used immediately preceding the voice audio for a given picture. For example, in the First Say Activity when “le—van—TAR—me” (to get up) is introduced, the learner first hears in the audio track the sound of an alarm clock ringing loudly. The sound effect of an alarm clock ringing, therefore, here becomes a SoundFX Icon: a picture in sound which suggests directly the meaning of what is being talked about. These SoundFX Icons either portray exactly what is depicted in a given picture, or serve to add narrative or dramatic context. SoundFX Icons serve the same function as the pictures in this system and method: to provide imagistic context and mnemonic advantage for the specific elements of spoken language being learned. This mapping of meaning via a sound effect or ambient sound is here described as SoundFX Icon Semantic Indexing.

### Visual Patterning (Mapping) of Spoken Performed) Language

Visual patterning occurs in that what is being talked about on the voiced audio is always mapped to one, consistent, stable visual referent (picture)—a simple drawing, an icon, a photograph, a still video image—on the screen. This process is called Visio-Semantic Indexing. Individual words and phrases are then grouped together and presented on a screen in a matrixed array of logically or conversationally related language and pictures. This matrixed array is called the Performing Picture-Page. All of these screens (pages) of related language are mapped onto a mnemonic, visual superstructure called the Imaging Super-Matrix.

The entire superstructure of the Imaging Super-Matrix acquires a visio-syndetic, mnemonic advantage for the learner in that by accessing a particular picture in memory, she/he will then have the facility of seeing other similarly grouped pictures in memory. The learning system is specifically designed for students to learn not only single words or phrases, but also entire screens of logically or functionally related language. Specific activities emphasize the visual patterning (mapping) of pictures and, thereby, spoken language into memory.

### Speaking Rehearsal Patterning (Mapping) of Spoken (Performed) Language

Most preferably, and characteristic of the entirely participatory dynamic of the system and method of the invention, speaking rehearsal patterning (mapping) occurs throughout all the levels and activities of the system. Some activities (e.g., First Say, Round-and-Round, and Let's Talk!) are more intensive in the number of multiple and consecutive opportunities given to the learner to replicate exactly the performative audio models presented to her/him. These are classified as Immersive Speaking Rehearsal Activities. Speaking rehearsal mapping (patterning) is very much the “learning by doing” part of the entire system, method and environment.

This critical patterning (mapping) method is actively and continuously enabled by the audio and visual patterning techniques already mentioned above. For example, in speaking rehearsal patterning (mapping), learners may orally recreate the Bolding and Reverse Recursion audio patterning (mapping) techniques they hear performed by the system (e.g., within a First Say Activity). Learners may also be guided visually—in their retrieval and performance of new language—by the Talking Notes visual patterning (mapping) technique they see animated by the system (again, e.g., within a First Say Activity).

### Kinesthetic Rehearsal Patterning (Mapping) of Spoken Language

Kinesthetic patterning (mapping) of spoken language occurs, most preferably, with students physically miming actions being portrayed in pictorial, photographic or video images on the screen. For example, as a student learns how to say “to drink+milk”, she/he is encouraged not only to replicate the spoken audio, but also to mimic exactly the action seen in the picture of a teenage boy happily drinking a cold glass of delicious milk. This is an example of kinesthetic rehearsal mapping: the mapping of simple or more complex physical actions—such as eating, sleeping, or playing baseball—to a performed, spoken language element (SLE).

Learners are also encouraged to have appropriate props for a specific Speaking Rehearsal Unit, i.e., the progressive series of Levels and Activities which reveal, process and rehearse a given thematically related group of up to twenty new elements of spoken expression (living speech). Thus, in preparing for the Speaking Rehearsal Unit in which the student will learn how to say “to drink+milk”, she/he might have a glass handy during the activities to mimic the action of the picture fully and appropriately. In another Speaking Rehearsal Unit dealing with the numbers from one to twenty, the learner is encouraged to have real or play money (e.g., twenty cents or twenty dollars) in order to perform, along with the system, the progressive and recursive counting activities which occur on screen and in the voice audio. In another Speaking Rehearsal Unit dealing with words and expressions for telephone use, the learner is encouraged to have a cell phone handy to utilize in her/his performances of making a telephone call.

In summary, kinesthetic rehearsal mapping is an example of “learning by doing.”

### Dramatic Rehearsal Patterning (Mapping) of Spoken (Performed) Language

In dramatic rehearsal patterning (mapping) of spoken language, the learner is encouraged to mimic emotions being portrayed in picture or video images on the screen. For example, as a student learns to say “I'm happy!”, she/he is encouraged not only to replicate the spoken audio, but also to mimic exactly the emotion seen in the picture of a young professional woman smiling profusely, with eyes beaming. Dramatic rehearsal patterning is achieved by portraying simple or complex emotions, or physical states involved in common, everyday expressions such as “I'm hungry”, “I'm angry!”, and “I love you!” Dramatic rehearsal patterning is “learning by doing” as well.

Kinesthetic and dramatic rehearsal patterning of language may occur side-by-side within the learning process of one audio element. For example, while saying “I'm hungry” (in Spanish, or other second language), a student can employ kinesthetic rehearsal mapping by bringing both hands to her/his stomach. Additionally, for dramatic patterning of the same audio language element, the student could deliver very expressively in her/his voice the feeling of being absolutely famished.

### Narrative Mapping (Patterning) of Spoken (Performed) Language

In narrative mapping (patterning) of language, specific words and phrases may be mapped to individual characters, places, objects, events, affective and/or dramatic details, and times in the overall narrative (story). The system has specific activities that work into memory “Who?” says a particular word or phrase on the screen map (e.g., any one of the six characters). Additionally, the system will work up (reveal and process) “Where?” something occurs (e.g., in the bedroom, the kitchen, etc.). The system could also have activities that work into memory “When?” something occurs (e.g., in the morning, in the afternoon, or in the evening).

In narrative patterning (mapping) of language, as language is being learned in entire natural groupings of language (Speaking Rehearsal Units), a type of simple, spatialized ‘narrative’ develops in the coming together of thematically related language. Each Performing Picture-Page, therefore, tells a specific story which the learner will be able to recall and retell from memory, by having worked through a progressive and recursive series of activities and Immersive Imaging Events.

It is, therefore, a second important learning objective of the system for students to also learn these narrative details of the story. These narrative details become powerful mnemonic anchors upon which to pin (associate) individual language elements (a word, a phrase, an expression, a short question, a short statement, etc.). E.g., in remembering how to say “le-van-TAR-me” (to get up) in a Spanish version of the invention, students will also be able to recall (visualize in their mind's eye) that it is Character D who is doing this action, that Character D is in the bedroom, that it is a cheery morning with birds chirping (a SoundFX Icon) and the sun shining through the window, and that the alarm clock has just sounded (another SoundFX Icon) to awaken Character D. Additionally, the learner will recall the narrative detail that this character is getting up at 7 o'clock, which is represented adjunctively by a separate Detail Picture collocated, juxtaposed together with the Main Picture of Character D getting up.

Recursive audio and visual elements of spoken language, as well as visual and other types of imagery may be presented recursively. In other words, the same pieces of spoken language are re-performed, re-enacted within the same activity with slightly different intonations and delivery (in order to avoid monotonous repetition). The same audio is then re-enacted, re-introduced in progressive activities and levels, all of which goes to create a multi-layered set of related learning experiences and environments.

The system, environment or method of the invention is for learners to stabilize in long-term memory a robust connection between a specific visual image (picture)—and its specific placement on a matrixed page—with a specific element of spoken language; or the robust connection of a specific visual image (picture) with a particular sound effect or other dramatic or narrative event which is visually portrayed in this image. This mnemonic goal is preferably achieved due to the combinatorial, immersive effect of processual and progressive activities, all of which have these recursive, performative dynamics built in.

### The Peforming Picture-Page and the Imaging Super-Matrix

The basic teaching and learning environment of this system and method is the Performing Picture-Page. This is a matrixed, visual (and audio), iconic information display in which, preferably, a single prominent visual image sits at the center of the page; and two to six additional and equally glanceable visual images are placed in an orderly clockwise formation around the image at the center of the page. These images can be a simple black and white drawing, an icon, a photograph, or a still image from a video. The image at the center of the matrix is called a Center Picture, and the images in the circular, clock formation are called Main Pictures. The entire matrix of Center Picture plus Main Pictures in combination is called a Picture Wheel.

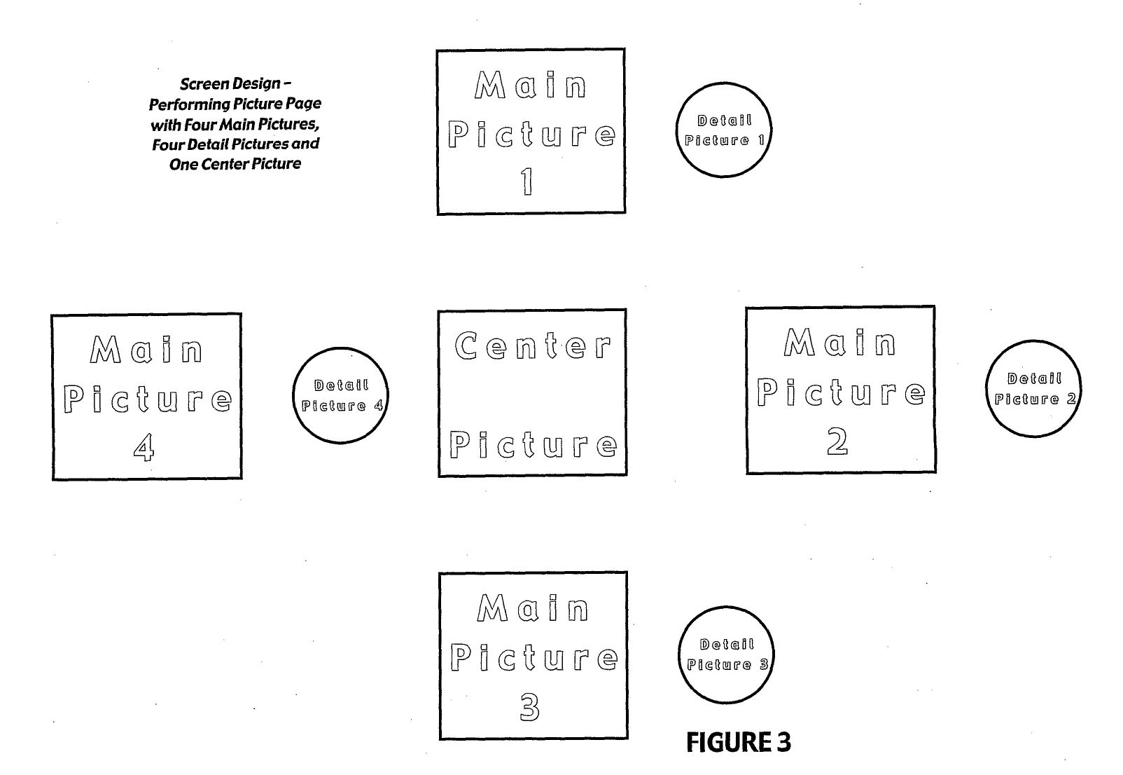

The Center Picture on the Performing Picture-Page will usually be an image that thematically unifies, and mnemonically anchors, the Main Pictures that surround the Center Picture on the matrix. The Main Pictures iconically represent the meaning of individual new elements of spoken interaction—a single word, phrase, statement, question, or expression—being revealed and processed by the system, and performed immersively by the learner, on a particular Performing Picture-Page. Both the Center Picture and its attendant Main Pictures fill up consistently sized, rectangular picture frames. (See FIG. 3, screen design example of a Performing Picture-Page with four Main Pictures.)

On some Performing Picture-Pages a third visual element is added. This is a Detail Picture which sits to the immediate right of a Main Picture, and can be visually distinguished from a Main Picture in that a Detail Picture is usually a bit smaller and fills up a circular, black-line picture frame. Like the Main Picture, the Detail Picture image can also be a simple black and white drawing, an icon, a photograph, or a still image from a video. The function of this secondary, adjunctive and collocated image is to add a logical, extended narrative detail to the spoken language represented in a Main Picture. Usually an individual Detail Picture, and its designated (embedded) audio element, will have been mastered already by the student in a previous Speaking Rehearsal Unit. The collocation of a specific Detail Picture to a Main Picture significantly strengthens the mnemonic value of the Main Picture. Thus, the learner is better able to recall and reproduce the Spanish word “le—van—TAR—me” (to get up), because she/he can also remember from the Detail Picture that it is at 7 o'clock that Character D is getting up. As such the Main Picture plus its matched (visually mapped) Detail Picture together constitute a Semantic Picture Collocation (FIG. 3).

Not all Performing Picture-Pages necessarily have adjunctive Detail Pictures. A Detail Picture is collocated (mapped) with a Main Picture only when that Detail Picture adds narrative, mnemonic and conversational value.

A Detail Picture may also be used to visually depict—in combination with a Main Picture and its audio element—a high frequency, spoken language collocation that exists in normal, everyday speech for the learner. For example, to the Main Picture of “ma—ne—JAR” (to drive) is added the Detail Picture representing “un CA—rro” (a car), because the phrase “to drive+a car” already exists as a high frequency verbal collocation in daily speech that a student can therefore use often in her/his spoken interactions. Detail Pictures, therefore, enable learners not only to learn single elements of language (e.g., a single word), but instead an entire group/phrase of words (i.e., a collocation). This process enhances immensely a learner's ability to produce more speech more quickly, and more fluently, at a given moment. Detail Pictures—via their role in creating Semantic Picture Collocations—add an important generative capacity (dynamic) to the system and environment of the invention.

During the running timeline of individual activities of the system, specific pictures on the Performing Picture-Page may alternately appear and disappear; their respective black picture frames will remain, however, in either state (e.g., in the Rebuild the Page Activity). The relative position (mapping) of a specific pictorial image on the Performing Picture-Page matrix usually does not vary, except when a Main Picture of one Performing Picture-Page becomes the anchoring Center Picture of another Performing Picture-Page. Additionally, during the running timeline of some activities of the system, individual picture images can be moved (dragged and dropped) by the learner to some other picture or “box” on the matrix (e.g., to the Listen-Box or to the Character Picture Box).

Each single Performing Picture-Page matrix is part of a specifically themed and titled Speaking Rehearsal Unit (represented graphically by two or three icons, or pictures) of usually two to five Performing Picture-Pages that in combination form one unit (e.g, “Acciones—En casa” [Actions—At home]). Each matrixed page reveals, processes and rehearses (usually) two to five new spoken language elements. (As such a Performing Picture-Page may have two to five Main Pictures, plus its anchoring Center Picture.) A Speaking Rehearsal Unit will reveal and process up to a maximum of twenty individual new language elements to be mastered by the learner. Each single Performing Picture-Page has a different Center Picture that thematically unifies the new language being presented on that page. All of the Center Pictures of these single pages can be found together as the Main Pictures of a related and previously mastered Performing Picture-Page. E.g., each of the rooms of the house, that appear as Center Pictures in the “Actions—At home” Speaking Rehearsal Unit, can be found originally as Main Pictures on the “At Home—Rooms” Performing Picture-Page.

At the next level of organization of the environment, each Speaking Rehearsal Unit is a subset of a broader categorization and mapping of Speaking Rehearsal Units on the meta-information architecture of the total environment, called the Imaging Super-Matrix (ISM). This Imaging Super-Matrix, therefore, represents the total aggregate of new language elements to be immersively revealed and processed by the entire system, and immersively imaged and rehearsed by the learner. In the Imaging Super-Matrix, dynamic information architecture, all language elements are visio-syndetically interconnected and interrelated; i.e., one picture (and its performative audio) connects logically with another picture on the same Performing Picture-Page, and that second picture will then connect with the picture of another matrix, and so forth throughout the system.

All of the performed, spoken language elements—and their corresponding visual and auditory imagery on the Imaging Super-Matrix—have a redintegrative memory effect: i.e., by remembering one picture, spoken language performance and/or rehearsal, or sound effect, one then recalls another. This redintegrative memory effect (tendency) enhances greatly the generative capacity of the entire Imaging Super-Matrix, in enabling and animating spontaneous and more abundant conversation in the learner.

Each Speaking Rehearsal Unit—and all the individual activities for any specific Performing Picture-Page—is accessible first by going through the Main Menu, and then the Sub-Menu of this matrixed, immersive imaging environment. When the student first starts up the program she/he will see the cover of a spiral notebook upon which are stamped six glowing icons in oval picture frames, located in Main Picture positions, i.e. arranged in a circular clockwise formation. (There is no Center Picture on the Main Menu or Sub-Menu picture matrixed pages.) This first dynamic matrix (also a type of Performing Picture-Page) serves as the Main Menu of the system and environment, and from here all individual Speaking Rehearsal Units, and their progressive layering of levels and activities, can be accessed.

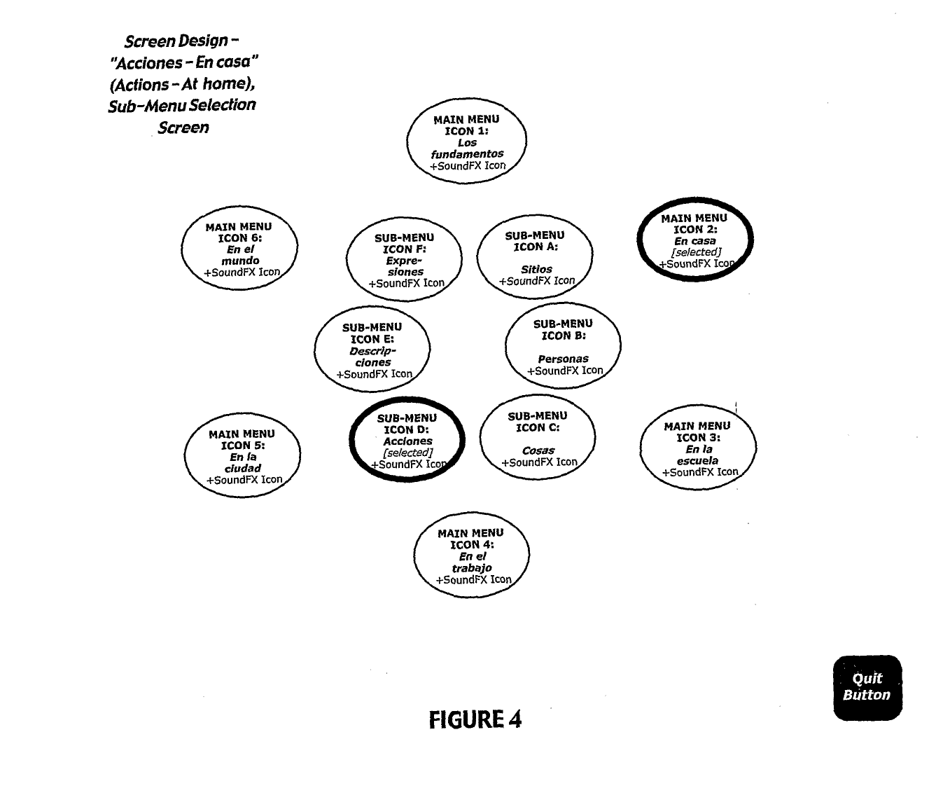

When the learner rolls the mouse over any one of the Main Menu icons, the icon highlights and an audio announces first in Spanish and then in English what first-order grouping of daily spoken language (interaction) can be accessed and learned via that particular icon. The learner then clicks on one of the six icons to select the main category of new language she/he wishes (or an instructor has requested her/him) to actively rehearse and perform with. For example, upon clicking the “En casa” (At home) charming house Main Menu icon, the icon highlights, a voice plus sound effect audio plays, and the Sub-Menu matrixed page then becomes visible as the first page in the book on the desktop. The Sub-Menu appears as a circle formation of smaller icons, all positioned—in a smaller, concentric circle—within the Main Menu icon circle. (See FIG. 4, screen design example of the “Acciones—En casa” [Actions—At home], Sub-Menu selection screen.) The Main Menu icons (here positioned as Main Pictures on a Performing Picture-Page) are now faded but still visible in the background. The “En casa” Main Menu selection icon is not faded and also remains highlighted from before, however. The student can now select from one of the six categories of sub-groupings of Speaking Rehearsal Units, and then select a Level of Activity to work with (usually Level 1, the beginning level). In summary, the Main Menu and Sub-Menu are also examples of this mnemonic, matrixed language learning system and environment.

Exemplary embodiments of the system, environment or method of the invention are explained in detail below. The example is intended to be illustrative and not limiting. The example involves the Spanish language, but of course any language may be employed. The example also involves a CD-ROM and the interaction occurs between the student and the computer. However, it should be understood that any suitable medium may be used, and the invention is not limited to such technical means. For example, even simple printed sheets with the Performing Picture-Page, visual information design described here, accompanied by the type of immersive imaging audio also described in this application, may be used to create the system and environment of the invention and employ the method of the invention.

### Level 1: First Look Activity

This is the opening activity of any specific Speaking Rehearsal Unit, i.e, a group of Performing Picture-Pages which all treat one logical or functional theme (e.g., “Acciones—En casa” [Actions at home]). (See FIG. 5, flow chart of the First Look Activity of Level 1.) The First Look Activity is the initial introduction to the meaning and positioning of individual pictures on individual Performing Picture-Pages, and their consistently embedded (mapped) audio elements of spoken language. It begins to work the visual patterning (mapping) of individual audio elements of spoken language to specific pictures—Visio-Semantic Indexing. Additionally, it begins to develop the narrative patterning (mapping) of spoken language to a specific character. Moreover, the First Look Activity provides a type of “stage directions” to the learner, in which she/he is encouraged to mimic the actions (kinesthetic mapping), and the emotions (dramatic mapping) portrayed in specific pictures and audio as they are revealed and processed. The learner may further be encouraged to have certain props handy during the activities to follow, in order to more fully dramatize the action represented in particular pictures (e.g., a glass for “to—MAR LE—che” [to drink milk], and a pen for “es—cri—BIR U—NA CAR—ta” [to write a letter]). The First Look Activity is not primarily a speaking rehearsal mapping activity. It is conducted in the native language of the learner (in English), with the exception of when a second (foreign) language word, phrase or expression is first introduced or reviewed in this activity (e.g., from a previously learned Detail Picture).

This activity opens with a screen, for example, of the “Acciones—En casa—Los cuartos” (Actions—At Home—Rooms) Performing Picture-Page on which one sees the “En casa” (At home) Center Picture in the middle of the page, and individual rooms of the house as Main Pictures in a clockwise formation around the “En casa” (At home) Center Picture. (See FIG. 6 of the First Look Activity of Level 1, Acciones—En casa—Los cuartos [Actions—At Home—Rooms] page.) An Activities Coach, who speaks in a personal and affirming way to the learner, reinforces the scope and purpose of the activity by stating that the learner is going to see, hear and rehearse language in the activities to follow (contained within this Speaking Rehearsal Unit), having to do with actions at home: in the bedroom, bathroom, kitchen, dining room and living room. The Activities Coach then calls the learner's attention to the “En casa” (At home) house icon serving as a Center Picture. Then the Activities Coach announces each of the locations in the house in Spanish (“ [symbol] En el dormitorio!— [symbol] En el ba\check{n}ol— [symbol] En el comedor!— [symbol] En la cocina!— [symbol] En el comedor— [symbol] En la sala!”). Each of the rooms around the picture matrix highlights while the picture is being named. This highlighting then disappears when the next picture is announced, and so forth around the Picture Wheel.

The screen then changes to the “Acciones—En casa—En el dormitorio” (Actions—At home—In the bedroom) picture matrix, which is the first Picture-Page in that Speaking Rehearsal Unit. The “En el dormitorio” (In the bedroom) drawing is now seen as a Center Picture in the middle of the page. Four other pictures representing the individual actions to be learned and rehearsed on this page, are placed as Main Pictures in a clockwise formation around the Center Picture. At this point the Activities Coach goes around the Picture Wheel in clockwise fashion introducing pertinent semantic, visual, audio, narrative and dramatic patterning (mapping) details about each picture. For example, at each Main Picture the Activities Coach will state in English what specific language element in Spanish (a word, phrase, expression, reaction, short question or statement) will be consistently represented by each picture. The specific meaning attached to, and represented by each Main Picture is made abundantly clear in English (or the learner's native language). As such, each new Spanish language element is Visio-Semantically Indexed to specific coordinates of the picture matrix.

The Activities Coach then encourages learners to carefully attend to specific visual, visual-spatial and narrative details of each Main Picture on the Performing Picture-Page that have an important mnemonic effect on the learner being able to later retrieve and reproduce the specific Spanish audio element represented iconically by each Main Picture. For example, the Activities Coach will encourage the learner to note carefully where on the matrix each Main Picture is located. Additionally the Coach will suggest to the learner to “Please take a picture, with your eyes and memory, of the entire Picture-Page!”, thus encouraging the student to integrate into memory the entire spatialized narrative, to see it as one visual and narrative unity. Furthermore, the Coach will review memorable narrative details about each Main Picture, including pertinent who?, what?, where?, why?, and how? pieces of information. Moreover, the Activities Coach will point out the visual or narrative connection between any mapped SoundFX Icons and each Main Picture. As such, the First Look Activity begins to “teach the picture,” as well as to “teach the Picture-Page” as a whole.

Pausing at each Main Picture, the Activities Coach will enunciate in Spanish the new spoken language element (SLE) for the first time for the learner: very slowly and over-articulately three times utilizing the Bolding technique, with pauses of silence in between to permit students to begin to take in the sounds. The student is encouraged not to attempt to replicate just yet the sounds in Spanish she/he is hearing. The learner is instead encouraged to listen very closely to the new sounds in Spanish she/he is hearing, and to look very closely at the details of the picture. This process is continued around the Picture Wheel introducing each picture, until each of the consistent (stable) meanings in English assigned to each Main Picture, the visual and narrative details of the Main Pictures, the visual-spatial details of the matrix (i.e., where one picture is in relation to another) and a first exposure to the sound dynamics of individual Spanish language elements are completed.

This introductory process is repeated, then, for each of the four remaining room pages (Picture Performing-Pages) of the house, and their specifically mapped actions in Spanish which take place in each of these rooms, until all of the rooms are covered. In total, up to twenty individual pictures and their twenty consistently associated Spanish audio elements will be introduced in a typical First Look Activity. After this introductory activity is completed once by the learner, she/he does not need to run through it again, unless the learner wishes to review the English equivalents for the Spanish audio elements, or desires to review visual and narrative details of each Main Picture, and visual-spatial characteristics of the page as a whole.

The only speaking that a learner may be encouraged to perform in this activity is on two possible occasions. One occasion is when the Activities Coach may at the very-onset of this activity have the learner announce, along with the Activities Coach, which characters are represented on a given Performing Picture-Page, thus also fulfilling an important narrative patterning (mapping) function. The system would announce in Spanish “Look! It's [name of Character A]!” . . . followed by a Learner Rehearsal Space” . . . “Look! It's [name of Character B]!” . . . followed by a Learner Rehearsal Space” . . . “Look! It's [name of Character C]!” . . . followed by a Learner Rehearsal Space . . . “Look! It's [name of Character D]!” followed by a Learner Rehearsal Space.

A second occasion is when any Detail Pictures are going to play a part of the Performing Picture Pages activities of a given Speaking Rehearsal Unit, then the spoken language element that they represent will be briefly reintroduced orally in Spanish by the Activities Coach, and re-performed by the learner. (Not all Performing Picture-Pages have Detail Pictures, although many do.) Detail Pictures will normally have been learned and rehearsed extensively already in a previous speaking Rehearsal Unit, where they were first presented in the system and environment as Main Pictures.

### Level 1: First Say Activity

The First Say Activity is primarily an intensive, speaking rehearsal mapping (patterning) activity. It is an immersive introduction to the individual sound features of a particular piece of spoken language through audio and visual patterning (mapping). First Say Activity is also a kinesthetic and dramatic mapping (patterning) activity of spoken language elements. This activity is the first of three successive Level 1 activities—First Say, Rebuild the Page, and Who Says It?—that all treat the same two to five spoken language elements of one Performing Picture-Page all at one time, before moving on to the next Performing Picture-Page (in a Speaking Rehearsal Unit). (See FIG. 7, flow chart of the First Say Activity of Level 1.) It is recommended that these three successive activities for one Picture-Page (i.e., one group of spoken language elements) be completed by the learner all during the same session for optimal language learning effect.

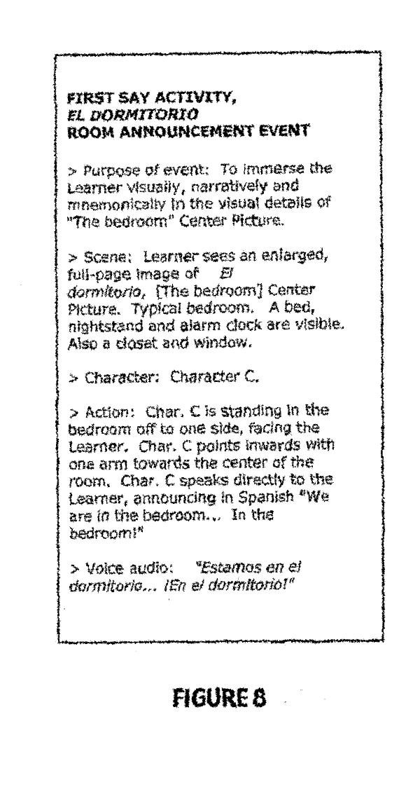

This intensive speaking rehearsal activity begins with a Room Announcement Event, in which the learner sees a full-screen image of “El dormitorio” (The bedroom) picture. (See FIG. 8, screen design description of the First Say Activity, “El dormitorio” [The Bedroom] Room Announcement Event of Level 1.) Character A, one of the cast of characters, speaking directly to the learner announces in Spanish “We are in the bedroom! . . . In the bedroom!” The purpose of this first Room Announcement Event is to immerse the learner visually (spatially), narratively, and thereby mnemonically, in the details of the bedroom. It puts the learner in the scene. This is important as the “El dormitorio” (The bedroom) Center Picture serves to anchor mnemonically the related language—four actions in the bedroom—which are about to be immersively revealed and processed in this First Say Activity.

A second purpose for the Room Announcement Event is to also reinforce mnemonically the “El dormitorio” (The bedroom) picture as an image that can be seen on the “Acciones—En casa—Los cuartos” (Actions—At Home—Rooms) Performing Picture-Page, which has pictures of the five rooms of the house in which the “Acciones—En casa” (Actions—At home) Speaking Rehearsal Unit takes place. (See FIG. 6.) Again, the purpose here is to teach the picture in all of its primary and secondary details, as well as to continue to reveal all of the sound features of a new spoken language element.

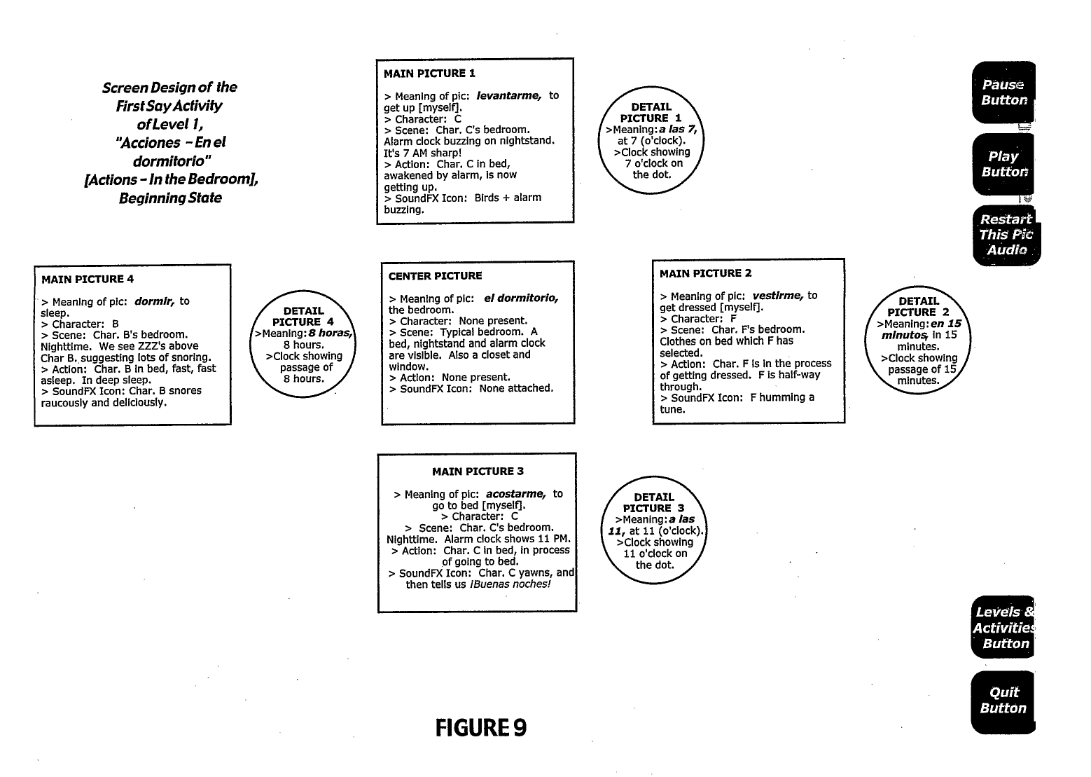

The next screen is of the “Acciones—En casa—En el dormitorio” (Actions—At home—In the bedroom) Performing Picture-Page. (See FIG. 9, First Say Activity of Level 1, “Acciones—En casa—En el dormitorio [Actions—At home—In the bedroom] page, beginning state.) Highlighting then surrounds the first picture at the top of the picture matrix pattern, in the 12 o'clock position. The revelation and processing of new language will start here, and then proceeds around the clock as the system and method reveal and process the remaining three pictures and their respectively embedded (mapped) audio for the learner.

In the first picture at the top of the “Acciones—En casa—En el dormitorio” Performance Picture-Page, the learner sees a clear, simple black and white drawing of Character D in bed who is in the process of getting up. In previous narrative mapping events and environments, the program will have already taught the learner Character D's first name. Additionally, in the aforementioned introductory First Look Activity, the character's name would have been reviewed and other details of the picture observed closely for their mnemonic value. In this same picture we also see a bright sun coming up in a window behind Character D's bed. The learner first hears the ambient sounds of morning birds happily chirping, followed immediately by the sound effect of a clock alarm going off. This combined, multiplexed mapping of visual, auditory, narrative and/or affective imagery together create a synaesthetic, mnemonic composite image in the learner's mind of a specific narrative event. This entire event—also referred to here as an Immersive Imaging Event (IIE)—creates a richly mnemonic stage upon which the target spoken, auditory imagery of “le—van—TAR—me” (the Spanish word “to get up”) can be revealed and recursively processed.

In this First Say Activity the elemental sound dynamics of “le—van—TAR—me” are recursively revealed and processed via Bolding: a very deliberate, usually syllable-by-syllable, purposefully slowed down, super-articulate, consciously exaggerated manner. The pedagogical goal of Bolding is to reveal for the learner every obvious and less obvious sound feature of specific elements (usually syllables) of new spoken language, much of which is hidden to the beginning student when she/he listens to high speed articulate speech (i.e., the type of speech usually spoken by native speakers in their daily interactions). In Bolding any or all of the following may be exaggerated for their enhanced perceptibility by the learner: individual vowel and consonant sounds, prosody, syllabic stress patterns, intonation patterns, as well as any emotional delivery features usually associated with a particular spoken language element.

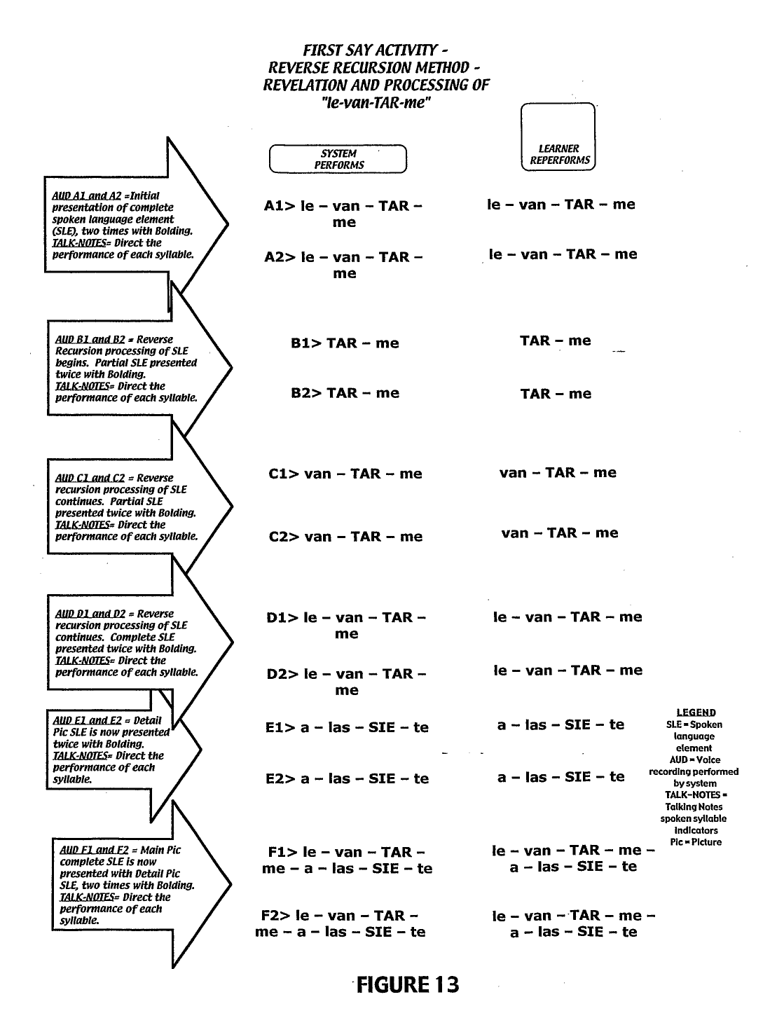

A second method (process) by which the presentation of new language in the First Say Activity is consciously altered for pedagogical and mnemonic reasons is Reverse Recursion. (See FIG. 13, flow chart of the First Say Activity of Level 1, Reverse Recursion method, revelation and processing of “le—van—TAR—me.”) The learner first hears the entire word “le—van—TAR—me” very slowly and carefully over-enunciated via Bolding, followed by a period of silence, lasting in time as long as it took for the system to present the sounds, during which the learner is encouraged to replicate, indeed “rehearse” exactly the sound features and entire performance she/he has just experienced. This period of silence, which is embedded in the timeline of the running activity, used here and in other activities of this system, method and environment, is called a Learner Rehearsal Space. The same process occurs one more time: the entire word is slowly and deliberately over-articulated, followed by another Learner Rehearsal Space during which the learner again recreates, re-enacts the spoken language performance with all of its auditory and dramatic embellishments.

Then proceeds the actual Reverse Recursion process. The learner hears “TAR—me” followed by a Learner Rehearsal Space; followed again by “TAR—me” and another Learner Rehearsal Space. In the next step of this recursive process the learner hears “van—TAR—me”, followed by a Learner Rehearsal Space; followed one more time by “van—TAR—me” and another Learner Rehearsal Space. Then the learner experiences the entire word performed, “le—van—TAR—me”, succeeded by another Learner Rehearsal Space. Then an additional performance of “le—van—TAR—me”, followed by a Learner Rehearsal Space. As such, the system and method has carefully and deliberately presented language, and the learner has had multiple and consecutive opportunities to reproduce the new elements of language, working progressively from the last syllable to the first, constructing the word in reverse fashion.

Next the First Say Activity presents “ [symbol] a—las—SIE—te!” (at 7 o'clock!). This audio represents the iconic meaning designated to the Detail Picture to the immediate right of the “le—van—TAR—me” Main Picture on the Performing Picture. The learner hears “ [symbol] a—las—SIE—te!”, succeeded by a Learner Rehearsal Space; then another “ [symbol] a—las—SIE—te!”, followed by a Learner Rehearsal Space.

Finally, as part of the Reverse Recursion method of revealing and processing new language in the First Say Activity, the audio of the Main Picture and the Detail Picture are next combined to form a more complete, conversational statement: “to get up+at 7“clock”. The learner hears the entire statement, “le—van—TAR—me a las SIE—te”, followed by a Learner Rehearsal Space. “Le—van—TAR—me a las SIE—te” is re-enacted for one final performance, followed by a final Learner Rehearsal Space.

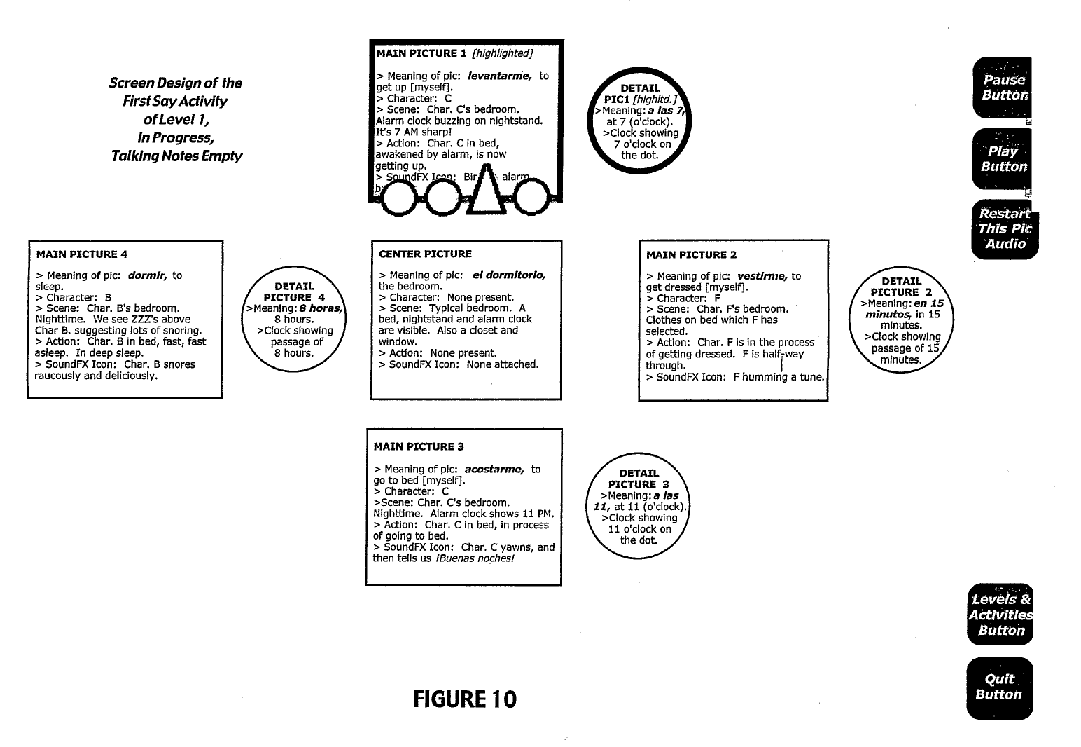

A third method (process) by which new language is revealed, processed and rehearsed in this First Say Activity is the use of Talking Notes, which create a dynamic, moving visual interface to guide a student in her/his retrieval and performance of new language being learned. (See FIGS. 10-12, First Say Activity of Level 1, Talking Notes.) As each single syllable of “le—van—TAR—me” is enunciated, blank Talking Notes—e.g., circles and triangles set in a row, one for each spoken syllable—sequentially fill in with either blue or red color. These create a type of extreme karaoke. (Blue filled circles signify unstressed syllables, and red filled triangles represent stressed syllables.) A period of silence—or Learner Rehearsal Space—equal to the time it took the system to say the syllable, syllables, words or phrase just enunciated, is embedded in the running time of the activity, after each performance of a part of a word or the whole word or phrase. During this Learner Rehearsal Space, the learner is invited to re-enact, re-perform, rehearse exactly what she/he has just heard. The Talking Notes also play during the Learner Rehearsal Space—in a time sequence pattern that follows exactly how the audio for the word was just presented to the learner—to visually guide and conduct the learner's speaking performance.

Language is learned mimetically (experientially) and progressively (processually). In this mnemonic immersive (performative) learning system and environment, spoken language is imprinted in the brain of the learner by means of a variety of mnemonic imagery stimuli and complex imagery events. Advantageously, learners are invited to speak new language as they also mime perform) an action, person, place, thing (Kinesthetic Mapping), description or emotion (Dramatic Mapping) that is being named in a variety of progressively structured activities. For example, as the student hears “le—van—TAR—me”, she or he will also be encouraged to mimic the action seen in the Main Picture of getting up in the morning. In another instance, the student will be encouraged to express incredulity by raising her/his hands to the heavens—as does Character C in one Main Picture of the narrative—while simultaneously pronouncing “ [symbol] Válgame Dios!”

### Level 1: Rebuild the Page Activity

The language learning and mnemonic purpose for the Rebuild the Page Activity is two-fold. First it is to provide the learner with a second audio patterning experience with the dynamic sound features of four new household actions embedded in the “Acciones—En casa—En el dormitorio” Picture-Page. This activity works primarily on comprehension and not production of oral language. As such, unlike the First Say Activity, it does not provide a series of Learner Rehearsal Spaces. Students, however, are encouraged to replicate the performative audio they hear as they participate in this activity. (See FIG. 14, flow chart of the Rebuild the Page Activity of Level 1.)

A second language learning and mnemonic purpose for the Rebuild the Page Activity is for the student to experience additional visual patterning of the specific locations on the Picture Wheel of individual Main Pictures, and their correspondingly embedded spoken language.

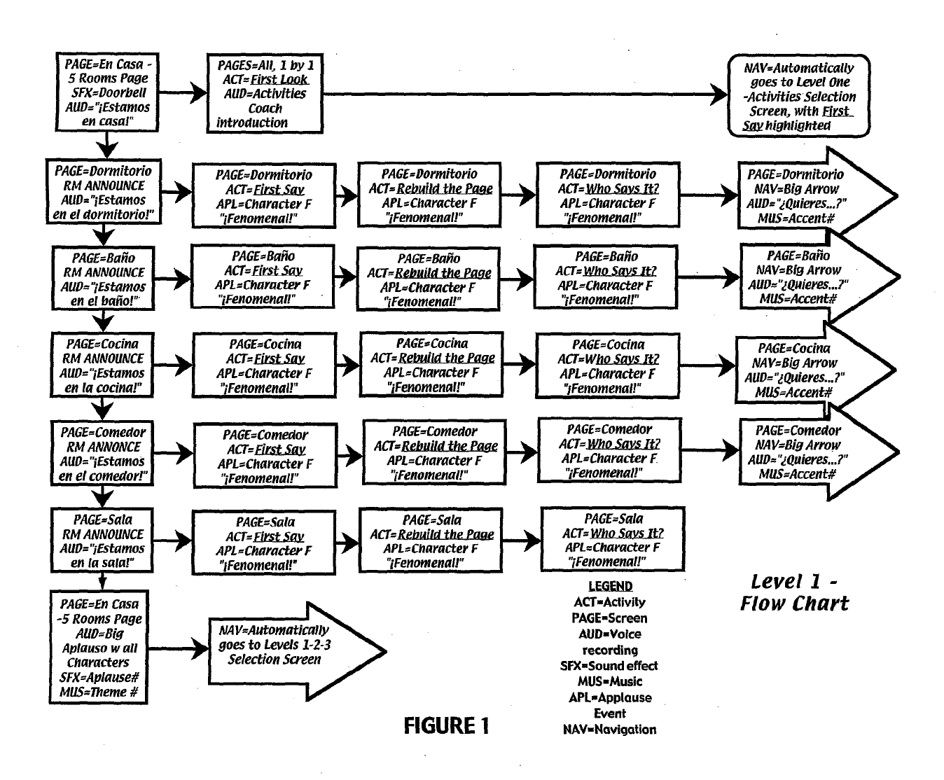

The Rebuild the Page Activity is designed usually to follow immediately after a First Say Activity for a specific page, and continues to reveal and mnemonically process the same two to five new words, phrases, short questions or statements—from one Performing Picture-Page—that were immersively introduced in the First Say Activity. (See FIG. 1, flow chart of the first level of the system of the invention.) The audio of spoken language heard in Rebuild the Page is still fairly slow, again to comfortably and kindly permit the learner to continue to discern nuances of pronunciation and articulation, prosody, intonation and stress patterns, and emotional delivery features of the language element. The speed of the voice audio here is the same as that of the First Say Activity.

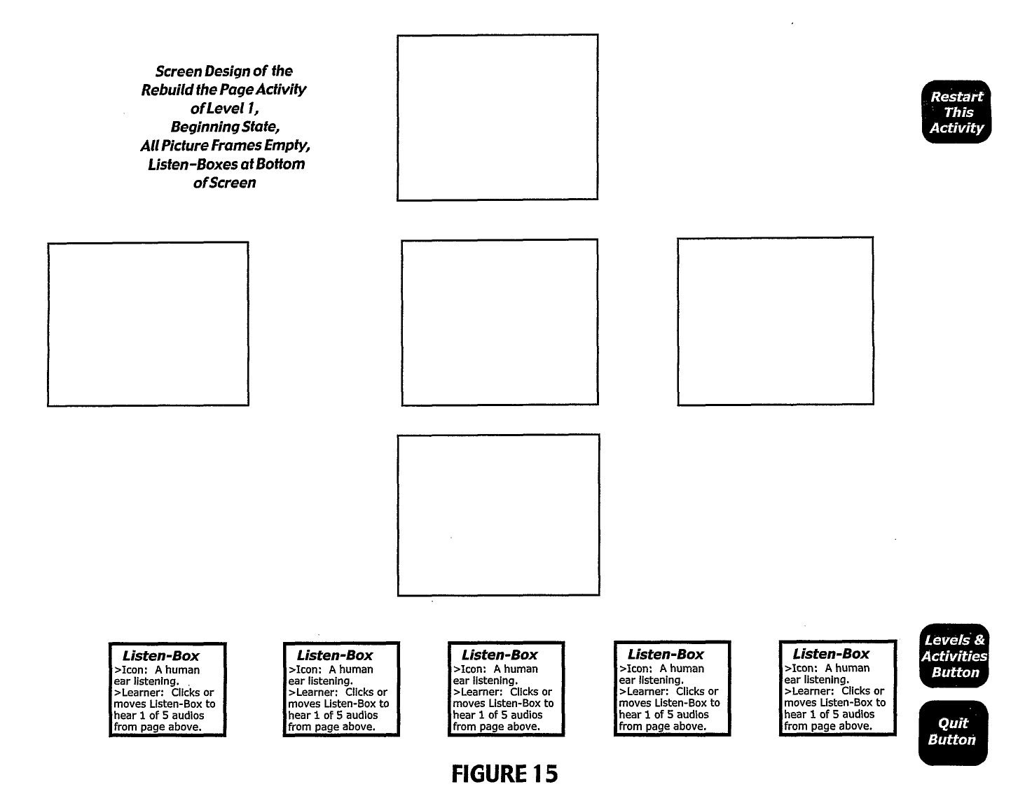

In the Rebuild the Page Activity in Level 1, the learner first sees a Performing Picture-Page in which all of the Main Pictures and Center Picture are blank and only five empty picture frames remain. (See FIG. 15, screen design example of the Rebuild the Page Activity of Level 1, beginning state.) At the bottom of the screen lie five Listen-Boxes in a row and in random order. The learner is instructed to click on any of the Listen-Boxes below to hear it play the audio of a Main Picture action and its collocated (matched) Detail Picture audio. The learner is further instructed to move individual Listen-Boxes up to where they belong on the Picture Wheel: i.e., where they belong on the Picture Wheel as they were just revealed, processed and rehearsed intensively in the previous First Say Activity. Each Listen-Box only plays the audio for one of the five Main Pictures (and its matched Detail Picture audio) or the Center Picture on the Picture Wheel in the preceding First Say Activity.

When the learner clicks on a Listen-Box, the audio will begin to play for a particular Main Picture (and its correspondingly matched Detail Picture), or the Center Picture. The audio will also begin to play if the learner begins to drag the Listen-Box anywhere across the screen, thus creating more Immersive Imaging with the audio, and another chance to determine where it belongs on the Picture Wheel. When the learner releases the Listen-Box, it returns to its original position at the bottom of the screen.

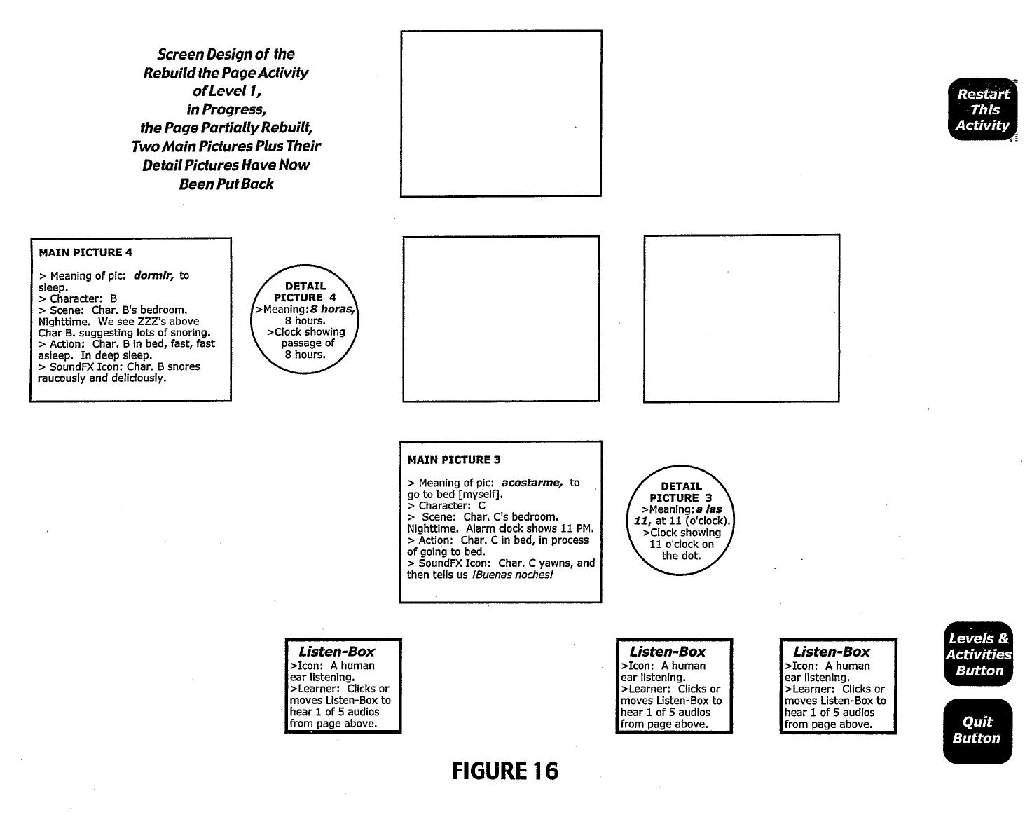

When a student drags and drops a Listen-Box to the right empty picture frame where that audio is regularly mapped on the Picture Wheel in the previous First Say Activity, then the empty frame on the Picture Wheel immediately fills up with the corresponding Main Picture or Center Picture. (See FIG. 16, screen design example of the Rebuild the Page Activity of Level 1, in progress.) In the case of Main Pictures, their collocated Detail Pictures also become visible. If a student attempts to move a Listen-Box—and, therefore, also its consistently embedded audio—to an incorrect location on the Picture Wheel, then the Listen-Box returns to its original starting position at the bottom of the page.

At the end, when the student has successfully “rebuilt the page” by matching all of the audio elements to their corresponding positions on the Picture Wheel, the Picture Wheel replays the audio one more time (in clockwise order) first for the Center Picture and then for the four matched Main Picture plus Detail Picture sets. As this occurs highlighting is added as a particular Center Picture, or Main Picture plus Detail Picture, play their audio. This reinforces even further both the visual mapping of each picture to its unique audio, and the visual-spatial mapping of each picture (and its embedded audio) on the Picture Wheel as a whole.

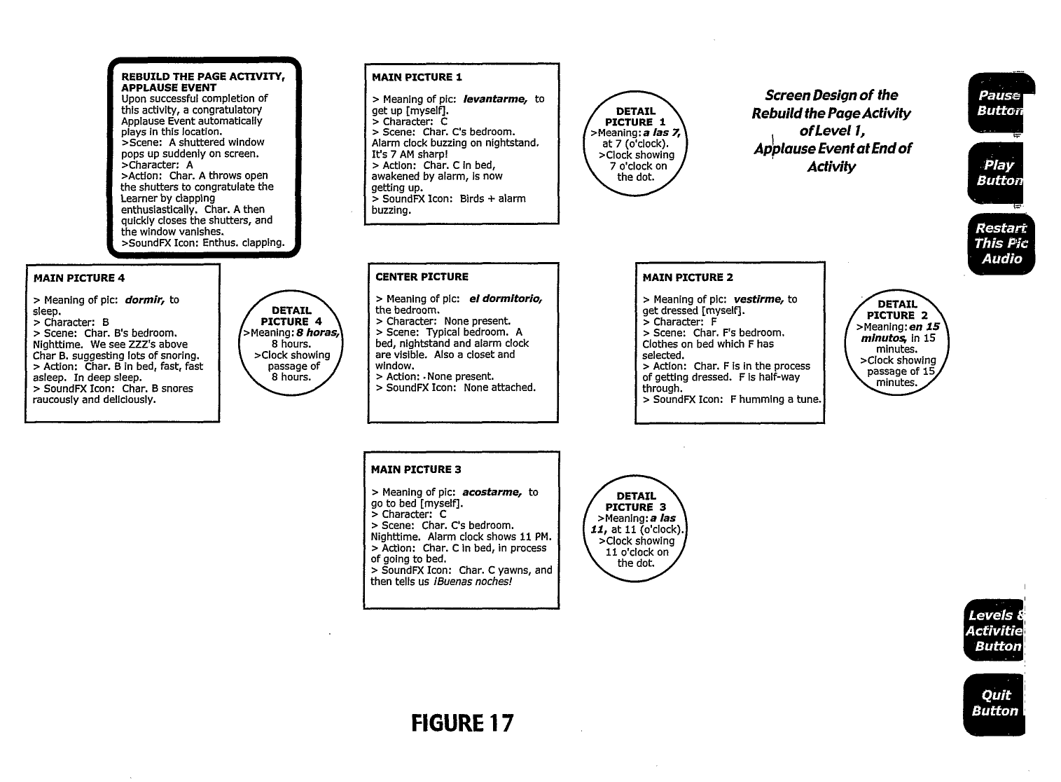

This Activity concludes with an Aplauso (Applause) Event. (See FIG. 17, screen design example of the Rebuild the Page Activity of Level 1, Applause Event.)

### Level 1: Who Says It? Activity

The Level 1 Who Says It? Activity is designed usually to follow immediately after a First Say Activity and Rebuild the Page Activity for a specific Performing Picture-Page. The Who Says It? Activity continues to mnemonically reveal and process the same two to five new words, phrases, short questions or statements that were revealed and processed in both the First Say and Rebuild the Page Activities. (See FIG. 1.)

The language learning and mnemonic purpose for the Level 1, Who Says It? Activity is two-fold. It is first for the student to experience narrative mapping patterning) of spoken language. In narrative mapping (patterning) of language, specific words and phrases are associated with specific characters, places, events, affective and/or dramatic details, and times in the overall narrative (story). The Who Says It? Activity works into memory “Who?” is saying and doing a particular action on the screen map (e.g., Characters A, B, C, D, E, or F). Narrative patterning (mapping) of language attains a highly significant mnemonic advantage for the learner in being able to retrieve and reproduce spoken language.

A significant second language learning purpose is to provide the learner with a third immersive imaging, audio patterning (mapping) experience (in this Speaking Rehearsal Unit) with the dynamic sound features of four new pieces of language, for example, the same four actions found on the “Acciones—En casa—En el dormitorio” Performing Picture-Page. As did the Rebuild the Page Activity, this activity also works primarily on comprehension rather than production of oral language (Speaking Rehearsal Mapping). It does not provide an embedded series of Learner Rehearsal Spaces as does the First Say Activity. As such this activity does not primarily work on speaking rehearsal mapping of language (although students are encouraged to replicate the sounds of the audio as they move the Listen-Boxes and hear the actions play.) (See FIG. 18, flow chart of the Who Says It? Activity of Level 1.)

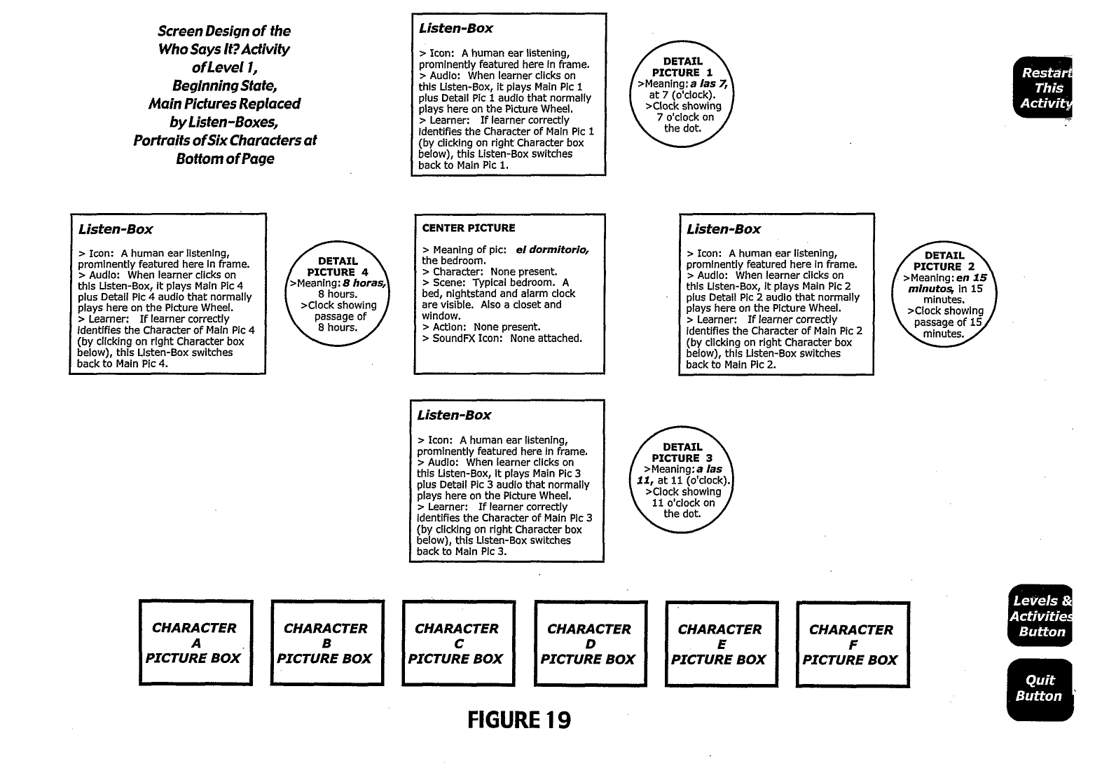

For example, the Level 1 Who Says It? Activity, e.g., in “Acciones—En casa—En el dormitorio” Speaking Rehearsal Unit, starts off with a screen in which the learner sees the picture matrix of the “El dormitorio” (The bedroom) page. The appearance of the page is the same except that all of the Main Pictures are missing, and a Listen-Box icon has replaced each of the four Main Pictures. The Center Picture depicting the bedroom remains visible, as well as each of the four Detail Pictures in their correct respective positions on the Performing Picture-Page. At the bottom of the screen lie six portraits (Character Pictures Boxes) in a row of the main Characters. (See FIG. 19, screen design example of the Who Says It? Activity of Level 1, beginning state.)

The learner is instructed to first click on any one of the four Listen-Boxes above on the Picture Wheel to hear it play the complete audio of the Main Picture action specifically matrixed to that position on the Picture Wheel, and its correspondingly matched Detail Picture audio. The learner is further instructed to then click on the Character Picture Box on the desktop below of the Character who is doing and saying that activity in the Main Picture. The learner is told that the Character in the picture will let the student know if indeed she or he is the one doing and saying the action.

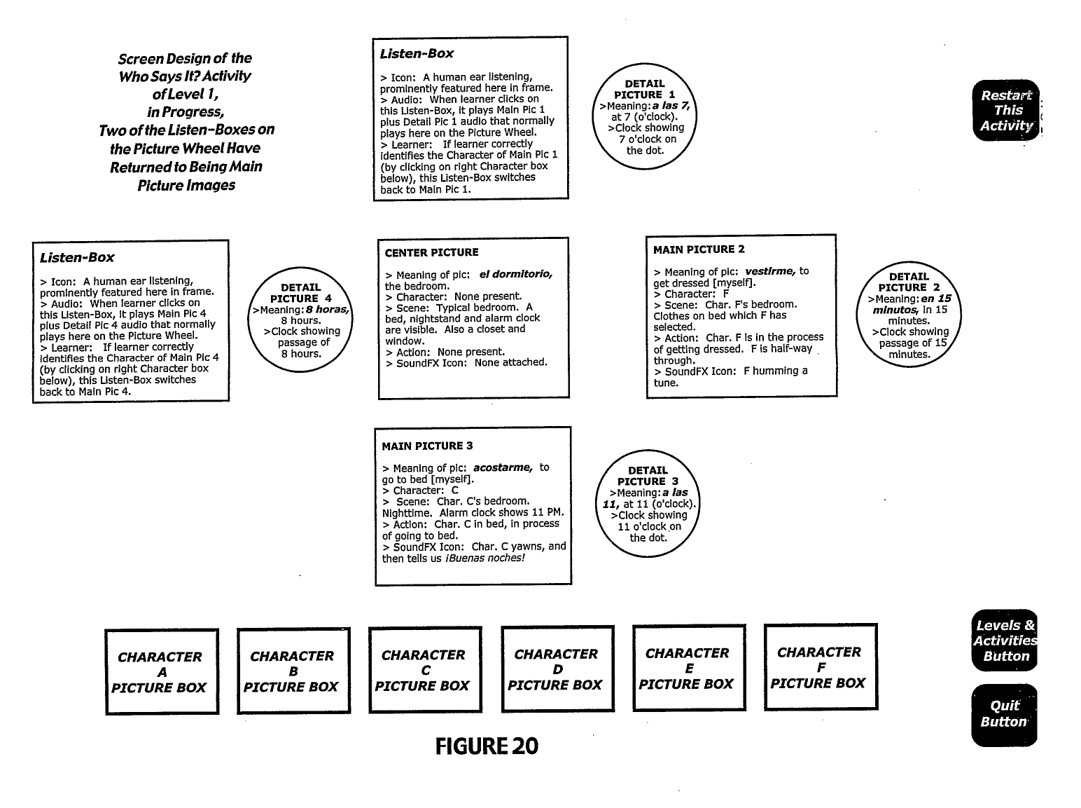

For a correct response—i.e., when the learner accurately identifies the character in the picture who is also the character saying the action in the audio, and performing the action the Main Picture—then the Listen-Box icon is immediately replaced by the right Main Picture which “lives” on the Picture Wheel in that location. (See FIG. 20, screen design example of the Who Says It? Activity of Level 1, in progress.) Soon after an audio begins to play in which the correctly identified character talks directly to the student, confirming that she/he is the person doing and saying that action. The Main Picture remains filled in for the remainder of the activity. The student first hears in this audio “ [symbol] Si! [symbol] Soy yo!” (“Yes! It's me!”). After saying “ [symbol] Si! [symbol] Soy yo!”, each character consistently then adds the same, personalized congratulatory expression. For example, Character D is always heard to add:. “ [symbol] Fenomenal!” (“That's great!”). Character B is always heard to say: “ [symbol] Que memoria! (“What a memory [you have]!”) These consistent congratulatory confirmations are maintained throughout the entire system of levels and activities, and provide a source of significant incidental language learning. They also contribute an incidental narrative patterning (mapping) advantage for the learner, in that the learner continues to get a sense of the unique personality and language style of each of the six characters.

For an incorrect response—i.e., the learner is unable to identify the character in the picture who is also doing and saying the action—then the Listen-Box icon remains visible and does not change into the right Main Picture for that coordinate on the Picture Wheel matrix. An audio begins to play in which the Character that the student has incorrectly chosen talks directly to the student, indicating that she/he is not the person doing and saying that action. The learner hears in this audio “No . . . No soy.” (“No . . . It's not me.”). At this point the learner has two options. The student can click again on the same Listen-Box icon to hear the audio play again for that particular action, to see if doing this will summon in her/his mind's eye the image of the character performing that action. Alternatively, the learner can make an additional character selection by clicking on another of the six Character Picture Boxes below, until she/he correctly identifies the right person in the picture for that particular Listen-Box audio action.

The activity thus proceeds with the student filling in the page with all of the Main Pictures in their respective places, by continuing to identify the corresponding characters in the audio mapped to each of the Listen-Boxes. The activity is successfully completed when all of the characters performing each of the actions heard in the audios for each of the four Listen-Box icons, and all of the four Main Pictures, become visible again. At the very end of Who Says It?, the system plays an Aplauso (Applause) Event celebrating the successful completion of this particular activity, and a glowing hand icon appears in the lower right hand screen prompting the learner to proceed then to the next group of new words to be learned. For example, at this point the student will have finished working with the four actions from “El dormitorio” (The bedroom) page. The learner can now advance to do a First Say Activity, Rebuild the Page Activity, and Who Says It? Activity with a second set of four actions on the “El baño” (The bathroom) page. The learner will thus continue through the system of activities until she/he has completed all five rooms in the “Acciones—En casa” (Actions—At home) natural grouping of new language.

### Level 2: Round-and-Round Activity

The Round-and-Round Activity is primarily an intensive speaking rehearsal mapping activity. For mnemonic and pedagogical reasons, it also works in a processual manner the visual mapping of spoken language onto the entire Performing Picture-Page matrix, for example, in a clockwise direction. Additionally, the Round-and-Round Activity produces narrative patterning (mapping) of language, as it is an intended purpose of this activity to pull together into a type of spatialized narrative or story the naturally and thematically grouped language being learned on each individual page of the activity. Each Performing Picture-Page, therefore, tells a specific story which the learner will be able to more readily recall and retell from memory, by having worked through the progressive series of activities and Immersive Imaging Events. (See FIG. 21, flow chart of the Round-and-Round Activity of Level 2.)

This intensive speaking rehearsal patterning (mapping) activity begins with a Room Announcement Event, in which the learner sees, for example, in the case of the “Acciones—En casa” (Actions—At home) language set, a full-screen image of “El dormitorio” (The bedroom) picture. (See FIG. 8.) This Room Announcement Event functions similarly to the Room Announcement Event in the First Say Activity. Character D, one of the cast of characters, announces in Spanish “We are in the bedroom! . . . In the bedroom!” The purpose of this Room Announcement Event at the beginning of this activity is again to immerse the learner visually, narratively and thereby mnemonically in the details of the bedroom.

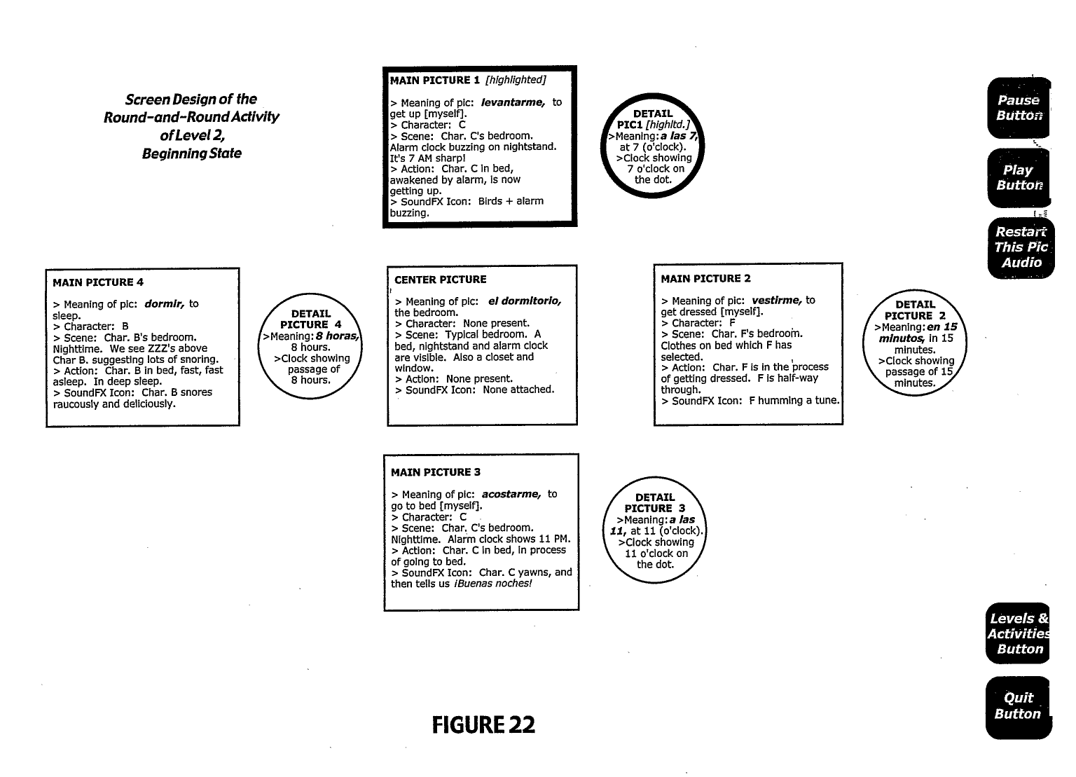

The system then automatically takes the learner to the “Acciones—En casa—En el dornitorio” (Actions—At home—In the bedroom) Performing Picture-Page matrix. All of the Main Pictures and their corresponding Detail Pictures, and the anchoring Center Picture are visible. Highlighting then surrounds the Main Picture and its related Detail Picture at the top of the Performing Picture-Page, in the 12 o'clock position. (See FIG. 22, screen design example of the Round-and-Round Activity of Level 2, beginning state.)

The continued revelation and processing of new language will start here, and then proceed “round-and-round” the clock picture pattern a total of three times.

An audio soon begins which performs, in a still over-articulated and highly expressive manner, “le—van—TAR—me+a—las—SIE—te.” In this Level 2 Round-and-Round Activity, the elemental sound dynamics of every word and phrase are revealed and processed for the learner again via a modified version of the Bolding technique first heard in the Level 1 First Say Activity. The speaking rate of this performance—and all others in this Level 2 Round-and-Round Activity—is a bit faster and less exaggerated than that of the initial introduction to this new language in the Level 1 First Say Activity. Each level of activities increases the rate of speaking by a small, incremental measure. The speaking rate within a level is usually all the same; it only shifts in pace as the student progresses from level to level in the system. The speaking rate of this Round-and-Round Activity, however, is still significantly slower than the kind of high-speed, articulate speech produced in everyday spoken interactions by native speakers.

After the audio of “le—van—TAR—me+a las SIE—te” is performed by the system, then a silent Learner Rehearsal Space follows. The student is here to re-perform “le—van—TAR—me+a las SIE—te” exactly as she/he has heard it in the preceding audio rendition. The time interval of this, and all Learner Rehearsal Spaces in this activity, has a duration that lasts a little bit longer than the original time it took for the system to perform it just ahead of the Learner Rehearsal Space.

Then the highlighting from the Main Picture and Detail Picture in the 12 o'clock position is removed, and highlighting surrounds the next language set of Main Picture plus Detail Picture at the 3'clock position of the Performing Picture-Page. The audio of ves—TIR—me+en QUIN—ce mi—NU—tos” (to get dressed [myself]+in 15 minutes) is then performed by the system, followed by a Learner Rehearsal Space. At this point, the student is to again perform the sounds and expressivity she/he has just heard articulated by the system.

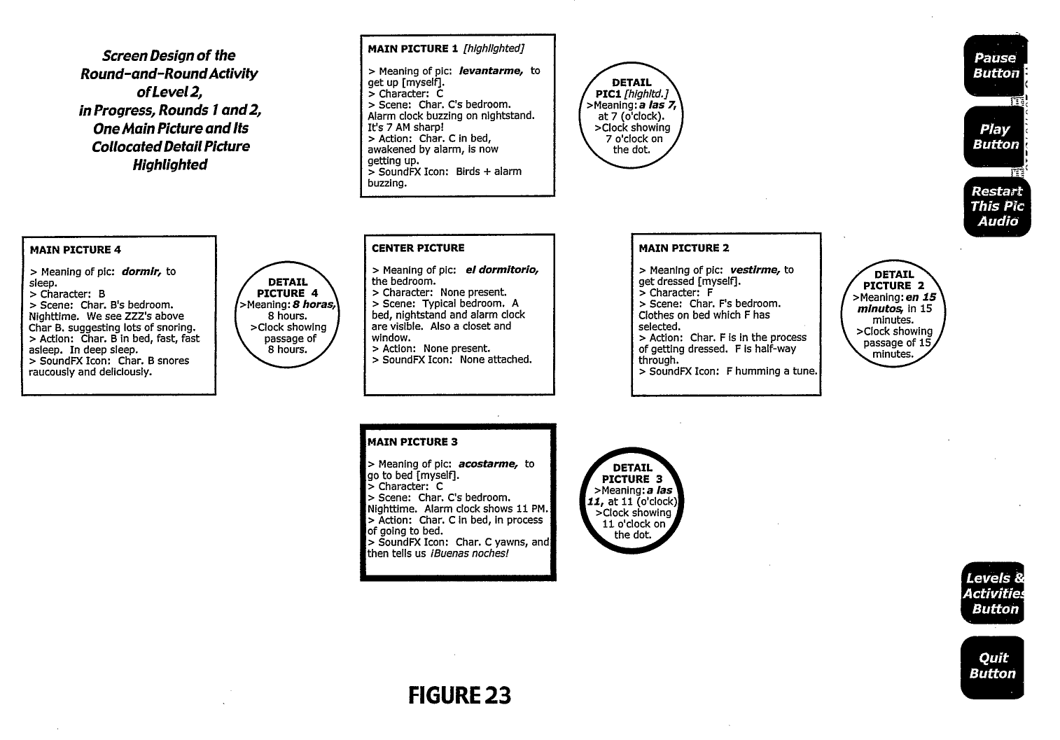

Then the highlighting from the Main Picture and Detail Picture at the 3 o'clock position is removed, and highlighting surrounds the next language set of Main Picture and Detail Picture at the 6'clock position of the Performing Picture-Page. (See FIG. 23, screen design example of the Round-and-Round Activity of Level 2, in progress.) The audio of “a—cos—TAR—me+a las ON—ce” (to go to bed at 11 o'clock) is then performed by the system, followed by a Learner Rehearsal Space. At this point, the student is to perform again the sounds and expressivity she/he has just heard enunciated by the system.

To complete his first round, the highlighting from the Main Picture and Detail Picture at the 6 o'clock position is removed, and highlighting surrounds the next language set of Main Picture plus Detail Picture at the 9'clock position of the Performing Picture-Page. The audio of “dor—MIR+O—cho HO—ras” (to sleep eight hours) is then performed by the system, followed by a Learner Rehearsal Space. At this point the student is to again re-articulate the sounds and expressivity she/he has just heard performed by the system. Round 1 of the Round-and-Round Activity is now completed. A hand appears in the lower right hand corner of the screen, which when clicked allows the learner to proceed to the next room (page) in the house and its language set of four actions at home.

Round 2 of this activity then follows. It proceeds exactly as the first round, with the highlighting surrounding a Main Picture and its related (collocated) Detail Picture, with a performance by the system of the audio for the Main Picture plus the Detail Picture, followed then by a Learner Rehearsal Space. This process travels around the clock formation from one Main Picture plus Detail Picture set to another, until this second round is completed.

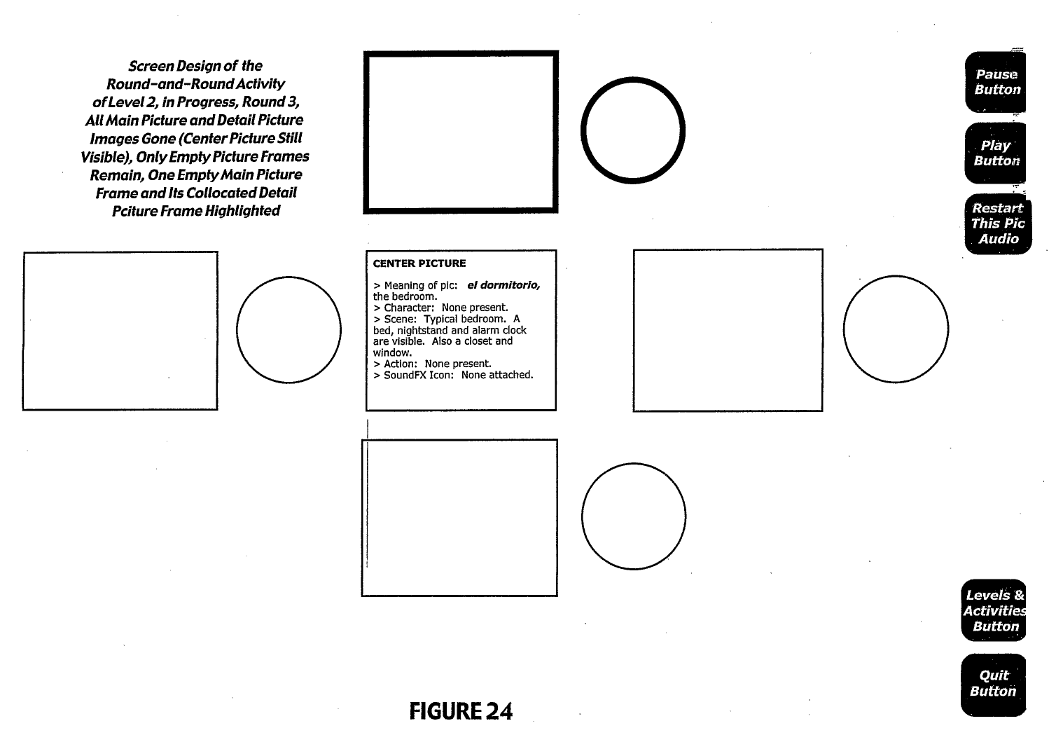

The third and final round (Round 3) of the Round-and-Round speaking activity then follows. (See FIG. 24, screen design example of the Round-and-Round Activity of Level 2, Round 3.) This constitutes an important visual-spatial patterning (mapping) sub-activity within the activity. At the beginning of Round 3, the learner now sees that all of the Main Pictures and their related Detail Pictures images have disappeared, and only empty picture frames remain in their respective spots on the clock matrix formation. The relative shapes and sizes of the Main Pictures and Detail Pictures, however, stay the same (i.e., empty rectangle frames remain for Main Pictures, and empty circular frames remain for Detail Pictures). The anchoring “El dormitorio” (The bedroom) Center Picture continues to be visible. Round 3 proceeds much like Round 1, with the highlighting surrounding a Main Picture frame and its related Detail Picture frame, with a performance by the system of the audio for the Main Picture plus the Detail Picture, followed then by a Learner Rehearsal Space. However, in this third round the highlighting surrounds only the empty picture frame of a Main Picture and its related Detail Picture, both while the system audio is performed and during the Learner Rehearsal Space. This process travels around the clock formation from Main Picture plus Detail Picture set, to Main Picture plus Detail Picture set, until Round 3 is completed.

The disappearance of the Main Picture and Detail Picture images (but not their picture frames) in this third and final round creates a crucial visual mapping (patterning) advantage for the learner. At the beginning of the activity, the system—via audio instructions—has suggested to the learner to try to actively visualize the missing pictures in her/his mind's eye, as the highlighting travels in a clockwise direction from frame to frame. Round 3, therefore, is a mnemonic visual imaging exercise that reinforces in memory the pictorial imagery seen in individual Main Picture plus Detail Picture sets (Semantic Picture Collocations). During the third round of this activity, as the learner hears the system say “le—van—TAR—me+a las SIE—te”, she/he should be able by this point in the progressive layering of activities and experiences, to visualize that it is indeed Character D who is getting up at 7 o'clock in the morning.

The disappearance of the Main Picture and Detail Picture images in this third and final round has a second significant visual and auditory mapping (patterning) advantage. Round 3 continues to work into memory not only the visual—and therefore also auditory—memory of each of the individual Main Pictures and their related Detail Pictures, but also intends to imprint mnemonically the entire aggregate of pictures on the page as one stable and coherent visual unit (visual-spatial mapping, or spatialized mapping). In Round 3 students are encouraged to image in the mind's eye each picture in its specific and special position on the matrix. It is an entirely conscious objective of the present method and system to teach not just individual pictures and their mapped (embedded) audio, but also to teach entire patterns (systems) of pictures with all of their collectively mapped spoken language and iconic sound effects audio. As such, the learner on the first bedroom page (of Actions—In the bedroom) learns not only “to get up”, but also the visually, thematically and conversationally related vocabulary of “to get dressed, to go to bed” and “to sleep.” Thus each Picture-Page is a visually and logically related set of connected conversational language. Again, the mnemonic learning objective here is for the learner to see and integrate not only individual pictures, but also very much to see and integrate an entire page into memory, and thus more easily be able to generate a wider range of conversation about a single topic or theme at a given moment.

Thus the Performing Picture-Page attains an important generative capacity in that it enables the learner to see and hear related language in memory that can be pulled easily into the speech stream during a spontaneous, casual conversation with another individual. And since each Performing Picture-Page—with its two to five new language items—is linked visio-syndetically to a broader, logical semantic unit (such as in the present case to the “Actions—At home” Speaking Rehearsal Unit), the actions of one page connect visually and logically to all of the other actions of the remaining rooms in the house. The generative capacity of the entire system is thus greatly enhanced by the visio-syndetic coupling of screen to screen to screen to screen to screen (e.g., in one typical Speaking Rehearsal Unit), and that group of five screens to yet another group of screens, and so forth throughout the Imaging Super-Matrix.

Round 3 of the Round-and-Round Activity acquires a third visual patterning (mapping) advantage in that the general, visual information design, and the teaching process of the system, is revealed and processed in a dynamic, clockwise direction, starting at the top of a Performing Picture-Page, and then proceeding Main Picture to Main Picture (and also to their collocated Detail Pictures, if these are also present) around the clock. Again, this activity reinforces the pictorially driven dynamics of how this activity and others in the system run preferably and optimally. This is also an example of visual-spatial (spatialized) mapping.

After Round 3 has concluded, all of the Main Picture and Detail Picture images return to view, allowing the learner to confirm the visual identity of pictures missing during the third and final round. This provides one more opportunity to review, relearn, and memorize the Main Pictures and their related Detailed Pictures which “live” on this particular Performing Picture-Page. A hand then appears in the right hand corner allowing the learner to go to the next Picture-Page for the second set of language in “Acciones—En casa” (Actions—At home). The process then repeats itself with all of the remaining four Performing Picture-Pages in this Speaking Rehearsal Unit—which represent a total of twenty new language items—until all of the rooms in the house and their respective spoken language elements have been covered.

This Round-and-Round Activity concludes with a congratulatory Aplauso (Applause) Event.

### Level 2: Where Does it Happen? Meta-Activity

The Where Does It Happen? Meta-Activity employs visual and narrative mapping of spoken language to a specific room in the house. It furthermore utilizes speaking rehearsal mapping of spoken language in that this is a speaking activity in which the learner is encouraged to replicate, for example, the actions of the house as she/he hears them performed by the system.

This activity is similar to, and expands upon the “Where Does it Happen? Activity” discussed above for Level 1. This Level 2 activity is a Meta-Activity; as such it brings together all of the new language learned in one natural language grouping (Speaking Rehearsal Unit). For example, it may utilize all twenty of the new actions learned in “Acciones—En casa” (Actions—At home) on five separate Performing Picture-Pages. In the Where Does It Happen? Meta-Activity the learner needs to identify in which of the five different rooms in the house a particular action occurs (i.e., on what room page an action is visually mapped. (E.g., “ba—NAR—me” [to bathe myself] is mapped on the “El bafio” [The bathroom] page). The learner will have prepared for this all-pages, Meta-Activity by having experienced and performed along with all of the preceding activities in Level 1 and Level 2, in particular the Level 1 Where Does It Happen? Activity.

In the language grouping of “Actions—At home”, there are a total of twenty different actions that a student will need to remember “Where Does it Happen?”, i.e., on what room page (in the bedroom, bathroom, kitchen, dining room, living room) a particular action is mapped. Students will identify where actions occur in a random order. The system will keep a tally on how well the student is doing. This activity is preferably web-enabled and used as an ongoing assessment feature for an instructor or for the personal use of the learner.

This Where Does It Happen? Meta-Activity proceeds specifically as follows. (See FIG. 25, flow chart of the Where does It Happen? Activity of Level 2.) The learner is presented with a screen in which a Performing Picture-Page is shown with a Listen-Box in the middle of the Picture Wheel, and the five pictures of the rooms of the house surrounding the Listen-Box positioned as Main Pictures. (See FIG. 26, screen design example of the Where Does It Happen Meta-Activity of Level 2.) This arrangement of Main Pictures of the rooms of the house is identical to the pattern of pictures and audio which a student would have already learned in a previous natural grouping of language called “En casa—Los cuartos” (At home—The rooms). There are no Detail Pictures on this picture matrix. Additionally, however, surrounding each Main Picture are four small empty boxes. For example, these represent the four actions at home that are learned on a particular room page. They are placed in the same positions where Main Pictures are placed around the anchoring Center Picture of a particular room page.

The student is instructed to click on the Listen-Box in the middle of the page. (with a listening ear icon) to hear a random action from any of the five rooms in the house. There are a total of 20 actions that can be randomly heard. When the student clicks on the Listen-Box, it highlights and the system then performs one of the actions from the total of twenty that are learned together in this “Actions—At home” natural language grouping (Speaking Rehearsal Unit). The performative audio used by the system here—which applies a Bolding technique and a slower rate of speaking—is identical to the one used in the Level 2 Round-and-Round Activity. The student is then encouraged to re-perform the audio she/he has just heard. The student is also instructed to then move (drag and drop) the Listen-Box to the picture of the right room where that action takes place in the house, and is thereby visio-syndetically mapped on the Performing Picture-Page for that room.

If the student moves the Listen-Box to the correct room, then the picture of that particular room first highlights and then switches to a picture of the Main Picture action that was just heard in the Listen-Box. The highlighting remains. Additionally, one of the small empty boxes that surrounds the picture of the room will fill in, in the same position where that Main Picture action is placed around the Center Picture of the room. This, therefore, re-enforces visual memory for the position of that action on that Performing Picture-Page. You then also hear, depending on the room, one of five congratulatory confirmations (in Spanish in the activity): “Very good! In the bedroom!; Very good! In the bathroom!; Very good! In the kitchen!; Very good! In the dining room!; Very good! In the living room!” At this point the audio for this correctly placed Main Picture and its collocated Detail Picture plays again, and the student is encouraged to re-enact the spoken performance one more time. At the close of this correct response sequence, the Main Picture of the action switches back to the Center Picture of the room.

For an incorrect response, i.e., if the student drags and drops the Listen-Box to the wrong room, an audio plays which states simply: “I'm sorry . . . . Not here.” The same process continues until the student correctly places the Listen-Box of the action in the right room of the house. The system will not permit the learner to place the Listen-Box audio in the wrong room. A scoring mechanism keeps track of how many correct first attempts are made.

If at any time the student wants to know how she/he is doing, the student can click on a Voiced Scoring button which appears in the right hand corner of the screen. This button will then change to a big fraction which shows how many actions out of 20 (in this case) she/he has correctly placed the first time around. The voiced audio then states in Spanish, for example, “Great! You now have 10 of 20!” in a highly affirmative, cheery manner.

At the end of twenty total attempts allowed for this activity during any one session, the Voiced Scoring comes on automatically to announce orally the student's score. The student then has the option of repeating the activity one more time in order to improve her/his score. The actions will play in the middle Listen-Box in a different order, however, than they did the first time the student attempted this activity.

This activity can be web-enabled and the scoring reported directly to an instructor for record keeping and assessment. This Where Does It Happen? Meta-Activity concludes with a congratulatory Aplauso (Applause) Event.

### Level 2: Who Say's It? Meta-Activity

The Level 2 Who Says It? Meta-Activity employs narrative mapping of spoken language to a specific character who is doing and saying, for example, an action in a picture. (A character may also be saying the word for a person, place, or object; or the character may be introducing a short expression or phrase.) It furthermore utilizes speaking rehearsal mapping of spoken language in that this is a speaking activity in which the learner is encouraged to replicate, e.g., the actions of the house which she/he is hearing performed by the system.

It also constitutes a Meta Activity in the sense that it combines all of the spoken language elements being learned across five separate Performing Picture-Pages. In Level 1, students performed individual Who Says It? Activities in which they were identifying the characters doing and saying actions for only one room (i.e., on one Performing Picture-Page).

This operates similarly to the Who Says It? Activity discussed above for Level 1. The difference is that the learner will need to identify which of the six different characters in the narrative is doing or saying a specific word, phrase, or expression in all five rooms (Picture-Pages) of the house. (See FIG. 27, flow chart of the Who Says It? Meta-Activity of Level 2.) In this natural language grouping of “Actions—At home”, there are a total of 20 different Main Picture actions that a student will need to remember the narrative mapping detail of “Who Says It?” Students will identify the character doing and saying an action in a random order. The system will keep a tally of how well the student is doing. This activity is preferably web-enabled and may be used as an ongoing assessment feature for an instructor or for the personal use of the learner. The learner will have prepared for this all-pages activity by having experienced and performed with all of the preceding activities in Level 1 and Level 2, in particular the Level 1 Who Says It? Activity.

Specifically, the Who Says It? Meta-Activity proceeds in the following manner. The student sees a screen with a Picture Wheel in which a Listen-Box icon is in the Center Picture position in the middle of the page. (See FIG. 28, screen design example of the Who Says It? Meta-Activity of Level 2, beginning state.) Surrounding this Listen-Box, in a Picture Wheel formation, are portraits (Character Picture Boxes) of the six characters who, for example, in the “Actions—At home” language set are seen doing and saying actions at home.

The student is instructed to click on the Listen-Box in the middle of the page (with a listening ear icon) to hear a random action play from any of the five rooms in the house. There are a total of 20 actions that can be randomly heard. When the student clicks on the Listen-Box, the system then performs one of the twenty Main Picture actions that are learned together in this “Actions—At home”, natural language grouping, plus its matched (collocated) Detail Picture audio. The performative audio used by the system here—which applies a Bolding technique and a slower rate of speaking—is identical to the one used in the Level 2 Round-and-Round Activity. The student is then encouraged to re-perform the audio she/he has just heard. The student is also instructed to then move (drag and drop) the Listen-Box to the Character Picture Box of the right character who is doing and saying that action plus detail, and is thereby narratively mapped on the Performing Picture-Page for that room.

If the student moves the Listen-Box to the correct character (Character Picture Box) who is doing and saying that action, the picture of that character first highlights and remains highlighted. Second, the picture of the correct character then switches to the same image (picture) of the Main Picture originally mapped to the audio (action plus detail) just heard in the Listen-Box. Third, the learner then hears—depending on the character who has just been correctly identified—one of the same six congratulatory confirmations heard originally in the Level 1 Who Says It? Activity. Finally, the audio for this switched Main Picture (plus its matched Detail Picture audio) plays again, and the student is encouraged to re-enact the spoken performance for that action plus detail one more time.

If the student attempts to move the Listen-Box to the wrong Character Picture Box, first the Character Picture Box remains the same and does not switch to a Main Picture. Second, an audio of the character wrongly identified will play which states simply: “I'm sorry . . . It's not me.” Third, the Listen-Box returns to its home position in the middle of the screen. (The system does not permit the learner to move the Listen-Box audio to the wrong Character Picture Box.) The Listen-Box remains highlighted until it is moved to the right Character Picture Box. This same process repeats until the learner correctly moves the Listen-Box of the action just heard to the right Character doing and saying that action plus detail. A scoring mechanism keeps track of how many correct first attempts are made.

Similar to the Where Does It Happen? Meta-Activity, if at any time the learner wants to know how she/he is doing, the student can click on a Voiced Scoring button which appears in the right hand corner of the screen. This button will then change to a big fraction which shows how many actions out of 20 (in this case) she/he has correctly placed the first time around. The voiced audio then states, for example, “You now have 10 of 20!” in a highly affirmative, cheery manner.

At the end of twenty total attempts allowed for this activity during any one session, the Voiced Scoring comes on automatically to announce orally the student's score. The student then has the option of repeating the activity another time in order to improve her/his score. However, the actions will play in the middle Listen-Box in a different (random) order than they did the first time the student attempted this activity.

This activity can be web-enabled and the scoring reported directly to an instructor for assessment and/or record keeping. This Who Says It? Meta-Activity concludes with a congratulatory Aplauso (Applause) Event.

### Level 3: Let's Talk! Activity

This activity creates mnemonic and performative immersion for specific elements of spoken, human interaction, and may be considered a preferred activity for inclusion into the invention. It is primarily an intensive speaking rehearsal patterning (mapping) activity; as such, it is an immersive re-introduction to individual sound features of a particular piece of spoken language, for example, by audio patterning. In this activity the learner is also encouraged to mimic the actions (kinesthetic mapping) and the emotions (dramatic mapping)—portrayed by a cast of live actors appearing in serial video segments—as they are revealed and processed. The learner may be futher encouraged to have certain props handy during the activity, in order to dramatize more fully the actors' actions and emotions. (See FIG. 29, flow chart of the Let's Talk! Activity of Level 3.)

Preferably, this is primarily a video-based activity. Students will see a cast of actors, most preferably live actors, who will approach the camera and perform a specific element of spoken language, one after the other, in the same order. Preferably, the actors are of different sex, age and ethnicity. The number of actors is most preferably four to six. (See FIG. 30, screen design example of the Let's Talk! Activity of Level 3.)

For example, in teaching the learner how to say “ [symbol] Fe—LIZ cum—ple—A—ños!” (Happy Birthday!), Actor One—against a blank, white screen will approach the camera (and, therefore, the learner) with a birthday cake in hand with lit candles. Then in a tight close-up of the actor's face and cake, smiling and with great expression, while offering the cake towards the camera and learner, Actor One will slowly and articulately say (perform) “ [symbol] Fe—LIZ cum—ple—A—ños!” (followed here by a Learner Rehearsal Space), and then again say (perform) “ [symbol] Fe—LIZ cum—ple—A—ños!” (followed again here by a Learner Rehearsal Space). During each Learner Rehearsal Space which is embedded in the timeline of the running activity, the learner is encouraged to recreate exactly both what the actor has spoken, and how she/he has performed the routine. In this Let's Talk! Activity, the actors will produce the elemental sound dynamics of every word and phrase via a modified Bolding technique already heard and rehearsed in the Level 2 Round-and-Round Activity. The speaking rate employed by the actors will also be similar to that of the Round-and-Round Activity, which is a bit faster and less exaggerated than that of the initial immersive introduction to this new language in the Level 1 First Say Activity. The scene then shifts to Actor Two, Three, and Four who will perform exactly the same routine (or Immersive Imaging Event) just described for Actor One. The activity then cycles back to Actor One and continues on to Actor Four, again dramatizing, articulating, and gesturing the same performance routine. In total, the learner will have interacted with the on-screen actors sixteen times, articulating and re-performing the same Immersive Imaging Event along with the actors.

An important learning dynamic in this Let's Talk! Activity is that it involves multiple and consecutive experiencing and performing by the learner. Students are encouraged to mimic every performative detail of the Immersive Imaging Event. Firstly, they are encouraged to replicate the exact, articulate pronunciation of the new language being performed by each actor. Secondly, and of great importance to its mnemonic effect, they are instructed to mimic all of the performance characteristics of the routine: facial expressions, enthusiastic tone of voice, and other gestures or actions that the actor is performing. (All four actors will perform fairly identical routines.) Additionally, the learner may be able to see the mouths of the speakers close up, which will greatly assist her/him in determining how to articulate these words, phrases, questions, statements and reactions.

For assessment and evaluation purposes, this activity is preferably web-enabled, and preferably, the audio that the student is performing can be saved and sent over the web to an instructor for evaluation and/or record keeping.

Other level three activities are, for example, a creative activity in which learners can create, for example, their own Performing Picture-Pages for use in the classroom; or their own talking, Performing Picture-Pages with voice-overs recorded by the students themselves to send to the instructor, or other students, family and friends. Preferably, this includes an activity in which a learner can Record and Mail her/his speaking rehearsals to an instructor for assessment and evaluation. This is a new type of homework made possible by the invention. Advantageously, students extensively rehearse spoken language, and then Record and Mail their rehearsals to their instructor for evaluation, or to someone else. This may be achieved, preferably, on the web (or perhaps together with another learner using this same system, environment or method).

Additionally, there may be an activity in which students can access a densely detailed graphic of a small community in which students can explore and learn individual vocabulary items just by clicking on a building, a vehicle or a person. The program automatically will give the student a “mini-lesson”—utilizing the Bolding and Recursion techniques employed by this system and method—on how to say (perform) that word or phrase.

I claim:

1. An immersive imaging system for learning a language comprising at least a first level, said first level comprising:
(d) a first activity that introduces a user of the system to the meaning and sound of a piece of spoken language;
(e) a second activity that works the visual mapping of spoken language on a picture matrix; and
(f) a third activity that works the narrative mapping of spoken language.

2. The immersive imaging system for learning a language of claim 1, further comprising a second level.

3. The immersive imaging system for learning a language of claim 2, wherein the second level comprises an activity that visually maps a spoken language to a coordinate on a picture matrix.

4. The immersive imaging system for learning a language of claim 3, wherein the second level further comprises a second activity that works visual mapping of a spoken language.

5. The immersive imaging system for learning a language of claim 4, wherein the second level further comprises an activity that works narrative mapping of a spoken language.

6. The immersive imaging system for learning a language of claim 5, further comprising a third level of language immersion involving mnemonic and performative immersion for elements of spoken interaction.

7. The immersive imaging system for learning a language of claim 6, wherein the spoken interaction is with a human actor.

8. The immersive imaging system for learning a language of claim 1, which is embodied on a CD-ROM.

9. The immersive imaging system for learning a language of claim 1, involving an interaction between the user and a computer.

10. The immersive imaging system for learning a language of claim 1, wherein the activity is a web-based activity.

11. An animated environment for learning a language comprising:
(a) audio patterning of spoken language by the use of spoken syllable indicators to create a visual interface;
(b) visual patterning by mapping the voiced audio to a consistent visual referent; and
(c) narrative patterning by mapping words and phrases to individual characters, places, objects, events and/or times.

12. A method of teaching a language to a human user by an immersive imaging system, which method comprises:
(a) presenting the user with an audio pattern of spoken language elements by the use of spoken syllable indicators to create a visual interface;
(b) reinforcing the memory of the user for the spoken language element by visual patterning by mapping the voiced audio to a consistent visual referent; and
(c) further reinforcing the memory of the user for the spoken language element by narrative patterning by mapping words and phrases to individual characters, places, objects, events and/or times.

13. The method of claim 12, wherein the user actively participates in the immersive imaging system.

14. The method of claim 13, wherein the user is interacting with a computer.
